(19) United States
(12) Patent Application Publication
(10) Pub. No.: US 2026/0254930 A1
(43) Pub. Date: Aug. 27, 2026

(54) ELECTRONIC APPARATUS AND CONTROL METHOD THEREOF

(71) Applicant: SAMSUNG ELECTRONICS CO., LTD., Suwon-si (KR)

(72) Inventors: Jinoh KIM, Suwon-si (KR); Gohwoon JEONG, Suwon-si (KR); Dosung JUNG, Suwon-si (KR)

(73) Assignee: SAMSUNG ELECTRONICS CO., LTD., Suwon-si (KR)

(21) Appl. No.: 19/648,787

(22) Filed: Apr. 15, 2026

Related U.S. Application Data
(63) Continuation of application No. PCT/KR2024/019202, filed on Nov. 28, 2024.

(30) Foreign Application Priority Data
Dec. 18, 2023 (KR) 10-2023-0185019

(51) Int. Cl. H04N 9/31; G06T 7/13; G06T 7/521; G06T 7/73; G09G 3/00

(52) U.S. Cl. CPC H04N 9/3179; G06T 7/13; G06T 7/521; G06T 7/73; G09G 3/002; G09G 2354/00

(57) ABSTRACT

An electronic apparatus including a sensor unit; a memory; a projection unit to output a projection image; and at least one processor. The at least one processor obtains edge information, based on a captured image of a projection surface area on which the projection image is to be output, through the sensor unit, and controls the projection unit, based on depth information acquired through the sensor unit, to output a projection image corrected to correspond to a projection area included in the projection surface area based on at least one of a first projection surface area or a second projection surface area included in the edge information obtained based on the captured image.

### CROSS-REFERENCE TO RELATED APPLICATIONS

This application is a continuation application, under 35 U.S.C. § 111(a), of international application No. PCT/KR2024/019202, filed Nov. 28, 2024, which claims priority under 35 U.S.C. § 119 to Korean Patent Application No. 10-2023-0185019, filed Dec. 18, 2023, the disclosures of which are incorporated herein by reference in their entireties.

### TECHNICAL FIELD

Apparatuses and methods consistent with the disclosure relate to an electronic apparatus and a control method thereof, and more particularly, to an electronic apparatus capable of outputting a projection image by determining one of multiple candidate projection areas, and a control method thereof.

### BACKGROUND ART

When an electronic apparatus performing a projection function outputs a projection image, the electronic apparatus may correct a projection image based on its arrangement and a projection direction toward a projection surface, thereby finally outputting the projection image.

A representative example of correcting an image may include keystone correction. The keystone correction may refer to an operation of correcting a trapezoidal image into a rectangular shape. Specifically, it may be determined whether the keystone correction is required based on a direction in which the electronic apparatus projects toward the projection surface. The function of automatically performing the keystone correction may be a keystone function.

Even when a projector outputs the corrected projection image to the projection surface, a user may experience discomfort viewing the output image based on a projection position of the projector. This is because distortion worsens as an angle at which the correction is required increases.

When the projector outputting the projection image is fixed, the user manually moves the projector and adjust the projection angle. There may be inconvenience when a user manually operates the projector.

When the projector automatically identifies the projection surface, there is difficulty in determining which projection surface should be finally selected when multiple areas that may be determined as the projection surfaces are identified.

### DISCLOSURE OF INVENTION

### Solution to Problem

The present disclosure is designed to address the above-described problem, and an object of the present disclosure is to provide an electronic apparatus capable of analyzing a projection surface to determine one projection area to which a projection image is output from among multiple candidate areas, and a control method thereof.

In accordance with an aspect of the disclosure, an electronic apparatus includes a sensor unit including at least one sensor, a memory, a projection unit to output a projection image, and at least one processor, in which the at least one processor is configured to obtain edge information, based on a captured image of a projection surface area on which the projection image is to be output, through the sensor unit, and control the projection unit to output, based on depth information obtained through the sensor unit, the projection image corrected to correspond to a projection area included in the projection surface area based on at least one of a first projection surface area and a second projection surface area included in the edge information.

The at least one processor may be configured to identify an area corresponding to a plane having a size greater than or equal to a threshold size in the edge information as the first projection surface area and the second projection surface area.

The at least one processor may be configured to identify a first projection candidate area corresponding to the first projection surface area and a second projection candidate area corresponding to the second projection surface area from the edge information based on the depth information and preset resolution information, identify one of the first projection candidate area and the second projection candidate area as the projection area, and control the projection unit to output the projection image to the projection area.

The at least one processor may be configured to obtain the captured image through an image sensor included in the sensor unit, obtain first tilt information of the first projection surface area and second tilt information of the second projection surface area based on the depth information obtained through a distance sensor included in the sensor unit, identify the first projection candidate area based on the first tilt information, and identify the second projection candidate area based on the second tilt information, and the depth information may include a sparse depth map.

The at least one processor may be configured to obtain edge information including an outline of at least one object from the captured image.

The at least one processor may be configured to identify an area corresponding to the larger value of a first size of the first projection candidate area and a second size of the second projection candidate area as the projection area.

The at least one processor may be configured to obtain content information related to the projection image, and identify the projection area based on a user's gaze direction when a content type included in the content information is a preset type.

The captured image may be a first captured image, and the at least one processor may be configured to obtain a second captured image through an image sensor included in the sensor unit when the content type included in the content information is a preset type, identify the user's gaze direction included in the second captured image, and identify an area corresponding to the user's gaze direction from among the first projection candidate area and the second projection candidate area as the projection area.

The at least one processor may be configured to obtain position information of the projection area, obtain a projection position and a projection angle based on the position information of the projection area, and control the projection unit to output the projection image to the projection area based on the projection position and the projection angle.

The projection image may be a first projection image, and the at least one processor may be configured to perform a correction function on the first projection image based on the projection position and the projection angle to obtain a second projection image, and control the projection unit to output the second projection image to the projection area.

In accordance with another aspect of the disclosure, a control method of an electronic apparatus includes obtaining edge information based on a captured image of a projection surface area on which a projection image is to be output, and outputting the projection image corrected to correspond to a projection area included in the projection surface area based on depth information and at least one of a first projection surface area and a second projection surface area included in the edge information obtained based on the captured image.

The control method may include identifying an area corresponding to a plane greater than or equal to a threshold size in the edge information as the first projection surface area and the second projection surface area.

The control method may include identifying a first projection candidate area corresponding to the first projection surface area and a second projection candidate area corresponding to the second projection surface area from the edge information based on the depth information and preset resolution information, and identifying one of the first projection candidate area and the second projection candidate area as the projection area, and wherein the outputting of the projection image comprises outputting the projection image to the projection area.

The identifying of the projection area may include obtaining the captured image through an image sensor, obtaining first tilt information of the first projection surface area and second tilt information of the second projection surface area based on the depth information obtained through a distance sensor, identifying the first projection candidate area based on the first tilt information, and identifying the second projection candidate area based on the second tilt information, and the depth information includes a sparse depth map.

The obtaining of the edge information may include obtaining the edge information including an outline of at least one object from the captured image.

In the identifying of the projection area, an area corresponding to the larger value of a first size of the first projection candidate area and a second size of the second projection candidate area may be identified as the projection area.

In the identifying of the projection area, content information related to the projection image may be obtained, and when the content type included in the content information is a preset type, the projection area may be identified based on a user's gaze direction.

The captured image may be a first captured image, and in the identifying of the projection area, a second captured image may be obtained through an image sensor when the content type included in the content information is the preset type, the user's gaze direction included in the second captured image may be identified, and an area corresponding to the user's gaze direction may be identified as the projection area from among the first projection candidate area and the second projection candidate area.

In the outputting of the projection image, the position information of the projection area may be obtained, a projection position and a projection angle may be obtained based on the position information of the projection area, and the projection image to the projection area may be output based on the projection position and the projection angle.

### BRIEF DESCRIPTION OF DRAWINGS

FIG. 1 is a block diagram of an electronic apparatus according to an embodiment.

FIG. 2 is a block diagram for describing a specific configuration of the electronic apparatus of FIG. 1 according to an embodiment.

FIG. 3 is a diagram for describing an image projection process according to an embodiment.

FIG. 4 is a diagram for describing a captured image according to an embodiment.

FIG. 5 is a diagram for describing depth information according to an embodiment.

FIG. 6 is a diagram for describing edge information according to an embodiment.

FIG. 7 is a diagram for describing a projection surface according to an embodiment.

FIG. 8 is a diagram for describing a projection candidate area and a projection area according to an embodiment.

FIG. 9 is a diagram for describing an operation of obtaining the projection candidate area according to an embodiment.

FIG. 10 is a diagram for describing a horizontal tilt according to an embodiment.

FIG. 11 is a diagram for describing a vertical tilt according to an embodiment.

FIG. 12 is a diagram for describing horizontal distortion according to an embodiment.

FIG. 13 is a diagram for describing rotation information of an electronic apparatus according to an embodiment.

FIG. 14 is a diagram for describing rotation information of the projection surface according to an embodiment.

FIG. 15 is a diagram for describing z-axis rotation information of the projection surface according to an embodiment.

FIG. 16 is a diagram for describing y-axis rotation information of the projection surface according to an embodiment.

FIG. 17 is a diagram for describing an operation of performing a keystone function in consideration of a vertical tilt according to an embodiment.

FIG. 18 is a diagram for describing an operation of performing the keystone function in consideration of a horizontal tilt according to an embodiment.

FIG. 19 is a diagram for describing an operation of outputting a projection image to the projection area according to an embodiment.

FIG. 20 is a diagram for describing an operation of identifying multiple projection candidate areas according to an embodiment.

FIG. 21 is a diagram for describing an operation of determining a projection area in consideration of a user's gaze direction according to an embodiment.

FIG. 22 is a diagram for describing an operation of determining the projection area in consideration of the user's gaze direction according to an embodiment.

FIG. 23 is a diagram for describing an operation of determining the projection area based on a user input according to an embodiment.

FIG. 24 is a diagram for describing a guide screen for selecting the projection area according to an embodiment.

FIG. 25 is a diagram for describing the guide screen for selecting the projection area according to an embodiment.

FIG. 26 is a diagram for describing the guide screen for selecting the projection area according to an embodiment.

FIG. 27 is a diagram for describing an operation of performing projection settings according to an embodiment.

FIG. 28 is a diagram for describing an image correction operation according to an embodiment.

FIG. 29 is a diagram for describing a screen distortion ratio according to an embodiment.

FIG. 30 is a diagram for describing the screen correction ratio according to an embodiment.

FIG. 31 is a diagram for describing the screen correction ratio according to an embodiment.

FIG. 32 is a diagram for describing a control method of an electronic apparatus according to an embodiment.

FIG. 33 is a diagram for describing a mobile projector according to an embodiment.

FIG. 34 is a diagram for describing a distance between the projection surface and the electronic apparatus according to an embodiment.

FIG. 35 is a diagram for describing a movement operation of the electronic apparatus according to an embodiment.

FIG. 36 is a diagram for describing a notification regarding position movement, according to an embodiment.

FIG. 37 is a diagram for describing the keystone correction function according to an embodiment.

FIG. 38 is a diagram for describing the keystone correction function according to an embodiment.

FIG. 39 is a diagram for describing an operation of changing the projection area, according to an embodiment.

FIG. 40 is a diagram for describing an operation of outputting the projection image using a plurality of devices according to an embodiment.

FIG. 41 is a diagram for describing an operation of changing the projection image based on a distance.

### MODE FOR INVENTION

Hereinafter, the present disclosure will be described in detail with reference to the accompanying drawings.

General terms that are currently widely used were selected as terms used in embodiments of the present disclosure in consideration of functions in the present disclosure, but may be changed depending on the intention of those skilled in the art or a judicial precedent, the emergence of a new technique, and the like. In a specific case, terms arbitrarily chosen by an applicant may exist. In this case, the meaning of such terms will be mentioned in detail in a corresponding description portion of the present disclosure. Therefore, the terms used in the present disclosure should be defined on the basis of the meaning of the terms and the contents throughout the present disclosure rather than simple names of the terms.

In the disclosure, an expression “have,” “may have,” “include,” “may include,” or the like, indicates existence of a corresponding feature (for example, a numerical value, a function, an operation, a component such as a part, or the like), and does not exclude existence of an additional feature.

An expression “at least one of A and/or B” is to be understood to represent “A” or “B” or “any one of A and B.”

Expressions “first,” “second,” “1st” or “2nd” or the like, used in the present specification may indicate various components regardless of a sequence and/or importance of the components, will be used only in order to distinguish one component from the other components, and do not limit the corresponding components.

When it is mentioned that any component (for example: a first component) is (operatively or communicatively) coupled with/to or is connected to another component (for example: a second component), it is to be understood that any component is directly coupled to another component or may be coupled to another component through the other component (for example: a third component).

Singular expressions are intended to include plural expressions unless the context clearly represents otherwise. It will be further understood that the terms “comprises” or “have” used in this specification, specify the presence of stated features, steps, operations, components, parts mentioned in this specification, or a combination thereof, but do not preclude the presence or addition of one or more other features, numerals, steps, operations, components, parts, or a combination thereof.

In the disclosure, a “module” or a “~er/or” may perform at least one function or operation, and be implemented by hardware or software or be implemented by a combination of hardware and software. A plurality of “modules” or a plurality of “~ers/ors” may be integrated in at least one module and be implemented by at least one processor except for a ‘module’ or an ‘~er/or’ that needs to be implemented by specific hardware.

In the present disclosure, the term user may refer to a person using an electronic apparatus or a device (e.g., an artificial intelligence electronic apparatus) using an electronic apparatus.

Hereinafter, an embodiment of the disclosure will be described in detail with reference to the accompanying drawings.

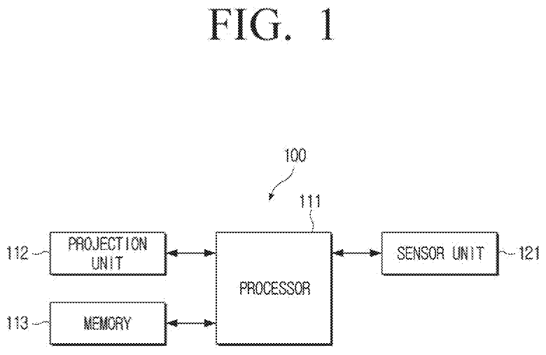

FIG. 1 is a block diagram illustrating an electronic apparatus 100 according to an embodiment.

Referring to FIG. 1, the electronic apparatus 100 may include at least one processor 111, a projection unit 112, a memory 113, and a sensor unit 121.

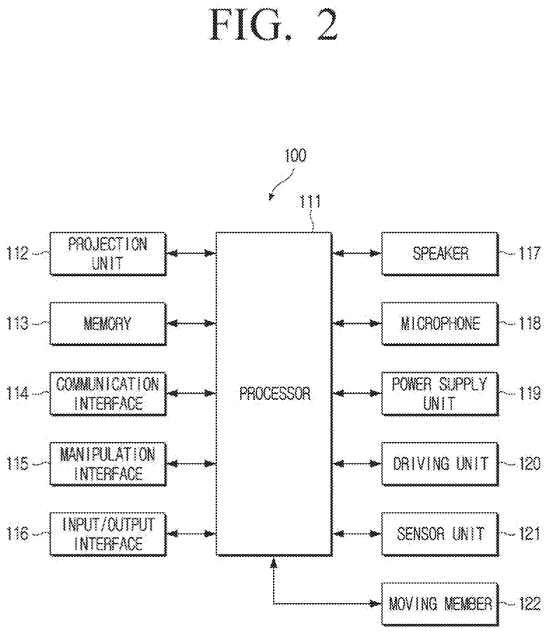

At least one processor 111 may perform an overall control operation of the electronic apparatus 100. Specifically, at least one processor 111 may perform a function of controlling an overall operation of the electronic apparatus 100. A detailed description of at least one processor 111 is described in FIG. 2.

The projection unit 112 is a component that projects images (projection image, content, etc.) to the outside. A detailed description of the projection unit is described in FIG. 2.

The memory 113 may store the projection image projected through the projection unit 112. The projection image may refer to not only a still image but also a continuous image (or video). The projection image may refer to an image included in the content. The memory 113 may store a driving O/S.

The sensor unit 121 may obtain sensing data. The sensor unit 121 may include at least one of an image sensor and a distance sensor. The sensing data may include at least one of image data (or captured image) and distance data.

At least one processor 111 may control various operations performed in the electronic apparatus 100.

At least one processor 111 may obtain edge information based on the captured image obtained through the sensor unit 121, identify a first projection surface area and a second projection surface area included in edge information based on depth information obtained through the sensor unit 121, identify a projection area based on one of the first projection surface area and the second projection surface area, and control the projection unit 112 to output a projection image corrected to correspond to the identified projection area.

At least one processor 111 may obtain the captured image and the depth information through the sensor unit 121, extract an outline included in the captured image to obtain edge information, identify a first projection surface area and a second projection surface area from the edge information, identify a first projection candidate area corresponding to the first projection surface area and a second projection candidate area corresponding to the second projection surface area from the edge information based on the depth information, determine one of the first projection candidate area and the second projection candidate area as the projection area, and control the projection unit 112 to output the projection image to the projection area.

The projection area may be described as a target area. In the description below, the terms projection area and target area are used interchangeably.

According to various embodiments, the electronic apparatus 100 may obtain sensing data at a fixed position. The electronic apparatus 100 may obtain the sensing data by rotating the sensor unit 121 in a y-axis direction or a z-axis direction at the fixed location.

According to various embodiments, the electronic apparatus 100 may obtain the sensing data while moving through a space in which the electronic apparatus 100 is positioned.

Based on the sensing data, the electronic apparatus 100 may obtain information about wall surfaces, a ceiling surface, a bottom surface, etc., of the space in which the electronic apparatus 100 is currently positioned. The electronic apparatus 100 may identify a projection surface area to which a projection image may be output from among the surfaces included in the space in which the electronic apparatus 100 is currently positioned.

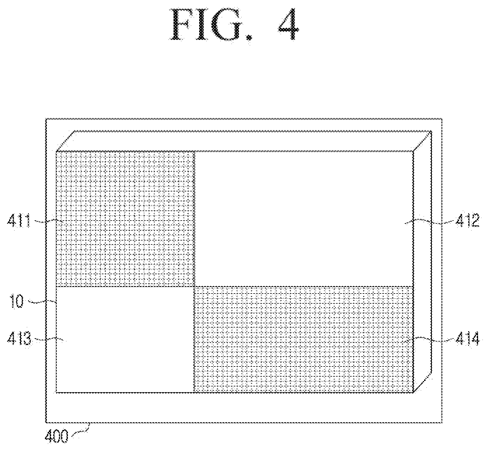

At least one processor 111 may obtain the captured image through the image sensor included in the sensor unit 121. The image sensor may include a camera. At least one processor 111 may obtain the captured image (or captured data) through the image sensor. A description of the captured image is described in FIG. 4.

At least one processor 111 may obtain the depth information through the distance sensor included in the sensor unit. The distance sensor may include a depth camera, a time of flight (ToF) sensor, a sparse depth camera, etc.

The depth information may include a sparse depth map. The sparse depth map may represent a depth map in which resources of distance data for each pixel included in an image are reduced to less than or equal to a threshold value. The distance units represented in the sparse depth map may be divided into a threshold range. For example, the sparse depth map may be divided into a first group (0 to 1 m), a second group (1 to 2 m), and a third group (3 m or more). The number of groups may be determined based on user settings or the characteristics of the sensor itself.

The electronic apparatus 100 may obtain the depth information through the distance sensor (or depth sensor). The depth information may be data less than or equal to a threshold resource. The depth information may include the sparse depth map. Using the sparse depth map may increase a processing time and a processing speed.

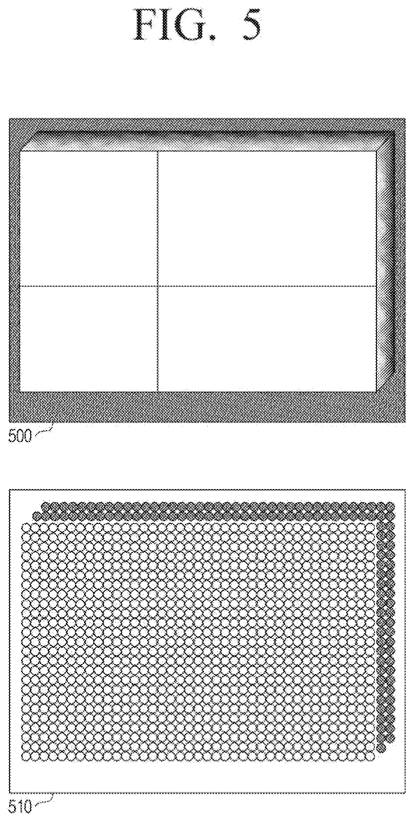

The depth information may be described as depth data, a depth map, etc. A description of the depth information is provided in FIG. 5.

According to various embodiments, at least one processor 111 may receive at least one of the captured image and the depth information through an external device. The external device may communicate with the electronic apparatus 100.

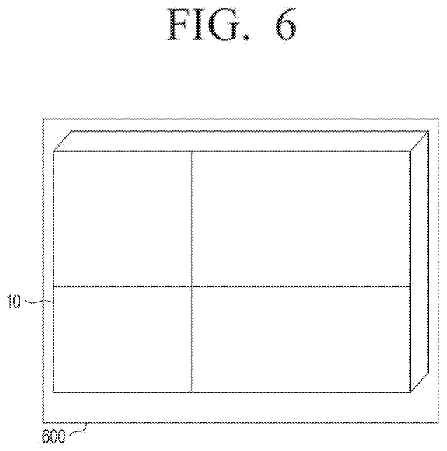

At least one processor 111 may identify at least one object in the captured image and obtain edge information including an outline of the at least one object. The edge information may include information extracted from only the outline (or contour) of at least one object included in the captured image. The edge information may be described as an edge map, edge data, edge map information, an edge image, etc. The description of the edge information is provided in FIG. 6.

At least one processor 111 may identify an area corresponding to a plane greater than or equal to a threshold size in the edge information as the projection surface area.

At least one processor 111 may identify at least one planar area in the edge information. The planar area may be described as an area corresponding to a plane, an area representing a plane, etc. At least one processor 111 may identify the size of the planar area. At least one processor 111 may identify the projection surface area by comparing the size of the planar area with a threshold size.

When a size of a specific planar area is greater than or equal to the threshold size, at least one processor 111 may determine the specific planar area as the projection surface area. The projection surface area may include an area identified as a projection surface or an area representing a plane to which the projection image may be output.

In order for the projection image to be output, the plane may need to have a minimum size. Therefore, the threshold size may be determined based on the minimum size on which the projection image may be projected. The threshold size may be changed according to the user's settings.

The electronic apparatus 100 may identify multiple projection surface areas.

According to various embodiments, it is assumed that a space has a first surface and a second surface. The electronic apparatus 100 may identify the first projection surface area on the first surface and the second projection surface area on the second surface.

According to various embodiments, the electronic apparatus 100 may identify the first projection surface area and the second projection surface area on the first surface.

According to various embodiments, the electronic apparatus 100 may identify the first projection surface area in a first space and the second projection surface area in a second space different from the first space. For example, the first space may be a living room and the second space may be a bedroom.

When a preset type of projection surface is identified from among multiple projection surfaces, the electronic apparatus 100 may assign priority to the identified projection surface and output the projection image. The preset type of projection surface may include a projection surface corresponding to a projection-only screen. The projection-only screen may be described as a projector screen, a projection screen panel, etc.

According to various embodiments, when the preset type of projection surface is identified from among the multiple projection surfaces, the electronic apparatus 100 may assign a relatively higher weight to the preset type of projection surface compared to other projection surfaces. Assigning the higher weight may increase the likelihood that the projection candidate area corresponding to the preset type of projection surface will be determined as the projection area.

At least one processor 111 may identify the first projection candidate area and the second projection candidate area based on at least one of the depth information and preset resolution information.

At least one processor 111 may identify at least one projection candidate area based on the projection surface area identified from the edge information. At least one processor 111 may identify a projection candidate area based on the preset resolution information. The preset resolution information may include basic size information for outputting the projection image.

The preset resolution information may include at least one of the horizontal size, vertical size, and horizontal and vertical size ratios of the image.

For example, the resolution information may include at least one of 1920*1080, 3840*2160, and 16:9.

For example, the resolution information may include at least one of 800*600, 1024*768, 1280*960, and 4:3.

At least one processor 111 may identify, based on the resolution information, an area to which a projection image is output from among the projection surface areas. Multiple actual areas where the projection image is output may be identified.

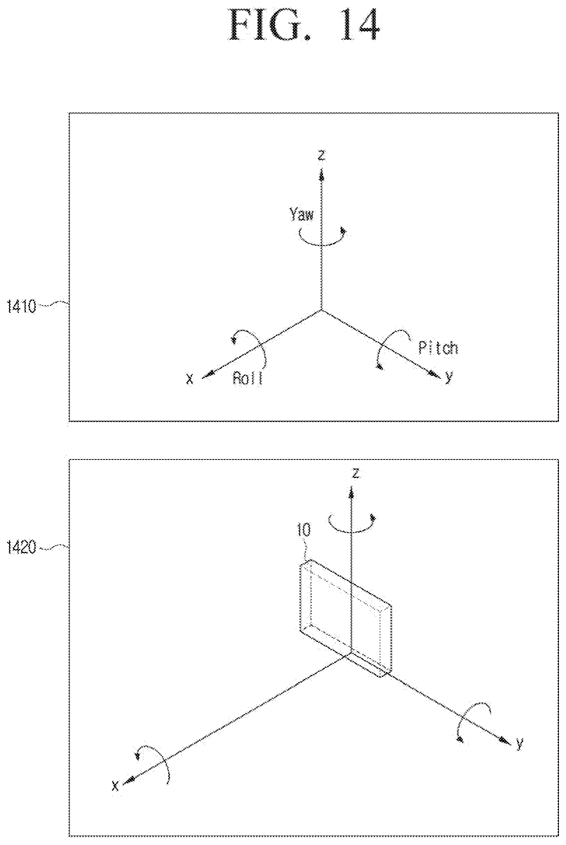

At least one processor 111 may identify the projection candidate area based on the depth information. At least one processor 111 may identify a rotation angle of the projection surface area based on the depth information. The rotation angle of the projection surface is described in FIG. 14.

At least one processor 111 may determine whether the projection surface area is suitable for outputting the projection image based on the rotation angle of the projection surface area. At least one processor 111 may identify the projection candidate area in the projection surface area when the rotation angle of the projection surface area is within a threshold angle. When the rotation angle of the projection surface area exceeds the threshold angle, at least one processor 111 may not identify the projection candidate area from among the projection surface areas. At least one processor 111 may obtain a tilt of the projection surface area (or projection surface) using the depth information.

At least one processor 111 may identify spatial information using the depth information. Obtaining the spatial information using both the captured image and the depth information may yield more accurate results than obtaining the spatial information using the captured image. The spatial information may be described as map information or depth map information.

At least one processor 111 may obtain tilt information for the first projection surface area and second tilt information for the second projection surface area based on the depth information. At least one processor 111 may identify the first projection candidate area based on the first tilt information and identify the second projection candidate area based on the second tilt information. A description of the tilt information is provided in FIG. 14.

When only one area where the projection image is to be output is identified from among the projection surface areas, at least one processor 111 may directly determine the identified area as the projection area. At least one processor 111 may directly output the projection image to the projection area. The projection area may include the area where the projection image is output. The projection area may be described as a target area, an image output area, a projection screen area, etc.

When multiple areas where the projection image is to be output are identified from among the projection surface areas, at least one processor 111 may determine the multiple identified areas as the projection candidate areas.

At least one processor 111 may identify at least one projection candidate area based on at least one projection surface area identified from the edge information.

At least one processor 111 may identify the first projection candidate area and the second projection candidate area.

For example, the first projection candidate area may be an area identified from the first projection surface area, and the second projection candidate area may be an area identified from the second projection surface area.

For example, the first projection candidate area and the second projection candidate area may be areas identified from a single projection surface area.

At least one processor 111 may determine the projection area based on at least one of the size of the projection candidate area, the content information, and the user's gaze direction.

According to various embodiments, at least one processor 111 may determine an area corresponding to the larger value of the first size of the first projection candidate area and the second size of the second projection candidate area as the projection area.

At least one processor 111 may obtain (or calculate) a first size of the first projection candidate area.

At least one processor 111 may obtain (or calculate) a second size of the second projection candidate area.

At least one processor 111 may compare the first size and the second size. At least one processor 111 may compare the first size and the second size and determine one of the first projection candidate area and the second projection candidate area as the projection area. The projection area may be an area corresponding to a position where the projection image is output.

At least one processor 111 may determine the projection candidate area having the largest size as the projection area from among the identified projection candidate areas.

At least one processor 111 may determine the projection candidate area corresponding to a larger size between the first size and the second size as the projection area.

According to various embodiments, at least one processor 111 may obtain the content information related to the projection image and, when the content type included in the content information is a preset type, determine the projection area based on the user's gaze direction.

The captured image may be a first captured image. When the content type included in the content information is a preset type, the at least one processor 111 may obtain a second captured image through the image sensor included in the sensor unit 121, identify the user's gaze direction included in the second captured image, and determine the area corresponding to the user's gaze direction as the projection area from among the first projection candidate area and the second projection candidate area.

The content information may include metadata that may represent the content. The metadata may include at least one of a content name, a content type, a content time, and a content size.

The preset type may include a type that provides specific information. For example, the preset type may include an information notification type that represents content for notifying date, schedule, weather, etc. For example, dramas, movies, etc., may not be included in the information notification type.

When the content type related to the projection image is included in a preset type, at least one processor 111 may determine the projection area in consideration of the user's gaze direction. At least one processor 111 may select the area corresponding to the user's gaze direction. At least one processor 111 may determine the projection area from the selected area.

According to various embodiments, at least one processor 111 may identify (or select) the projection surface area corresponding to the user's gaze direction from among multiple projection surface areas. At least one processor 111 may determine the projection candidate area from the identified (or selected) projection surface area. At least one processor 111 may determine the projection area from the determined projection candidate area.

According to various embodiments, at least one processor 111 may identify (or select) the projection surface area corresponding to the user's gaze direction from among the multiple projection surface areas. At least one processor 111 may determine the projection area from the identified (or selected) projection candidate area.

When the content type associated with the projection image is not included in a preset type, the projection surface area or the projection candidate area may be identified (or determined) using the content size without considering the user's gaze direction.

At least one processor 111 may obtain position information about the projection area, obtain a projection position and a projection angle based on the position information about the projection area, and control the projection unit 112 to output the projection image to the projection area based on the projection position and the projection angle.

At least one processor 111 may obtain information about the determined projection area. At least one processor 111 may obtain position information (or coordinate information) about the projection area. The information about the projection area includes position information, and the position information may include three-dimensional coordinate information.

At least one processor 111 may identify a projection position based on the position information of the projection area. The projection position may include a position to which the at least one processor 111 will move to output the projection image to the projection area. The projection ratio may be determined based on the physical characteristics of the projection unit 112. At least one processor 111 may identify the position to which the projection image is appropriately output, based on the distance between the projection surface 10 (or projection area) and the electronic apparatus 100 and the projection ratio.

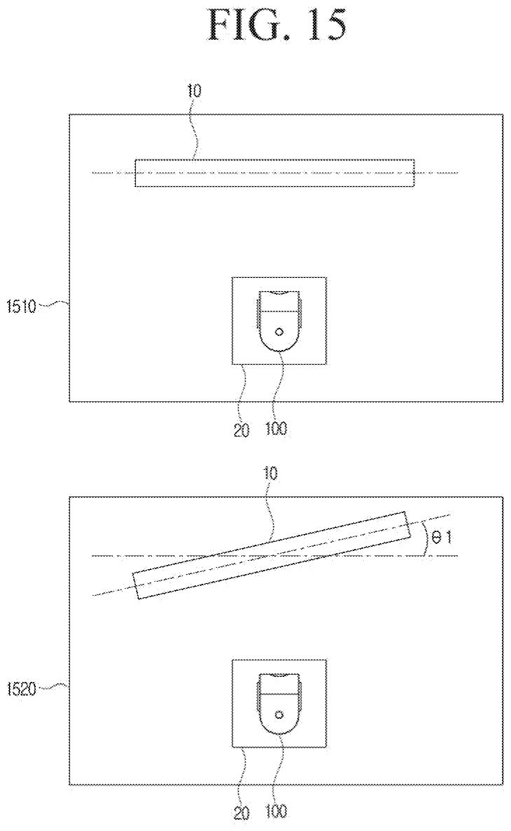

At least one processor 111 may determine the projection position such that the electronic apparatus 100 may face the projection area frontally. “Facing frontally” may refer to embodiment 1510 of FIG. 15.

When the projection position is determined, at least one processor 111 may move to the determined projection position. The electronic apparatus 100 may include the moving member 122. At least one processor 111 may supply power to the moving member 122 such that driving force generated by a motor or the like may be transferred to the moving member. At least one processor 111 may use the moving member 122 to move to the projection position.

At least one processor 111 may determine the projection angle based on the 3D coordinate information and the projection position. The at least one processor 111 may be configured to define the projection angle as indicating the projection direction for outputting the projection image.

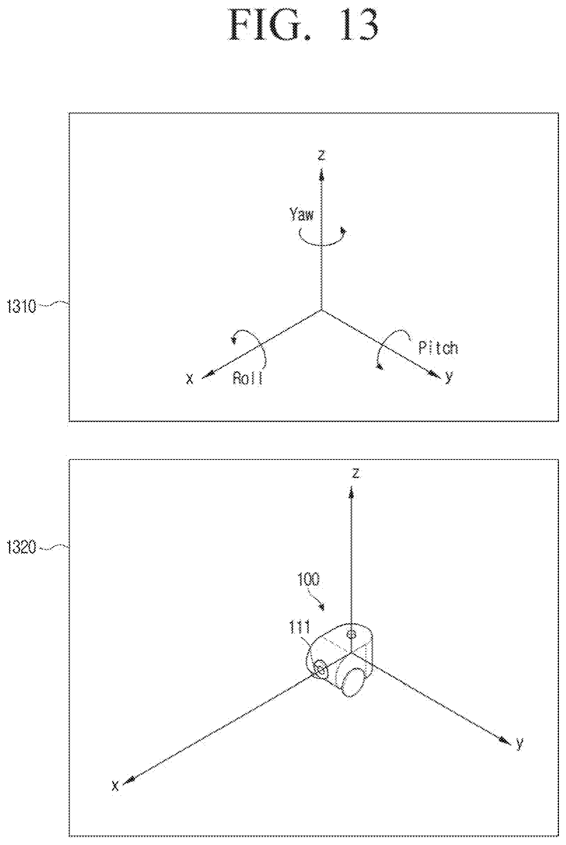

The at least one processor 111 may utilize the rotation function of the projection unit 112 itself. The at least one processor 111 may adjust the projection angle (or projection direction) by rotating the projection unit 112 from the fixed position. The projection angle may rotate based on the x-axis, y-axis, and z-axis as illustrated in FIG. 13.

The projection image is a first projection image, and at least one processor 111 may perform a correction function on the first projection image based on the projection position and the projection angle to obtain a second projection image and control the projection unit 112 to output the second projection image to the projection area.

The correction function may include performing a keystone correction function, a leveling correction function, and a resolution change function.

The keystone correction may refer to an operation of correcting a trapezoidal image into a rectangular shape. The leveling function may refer to a function of rotating an image. The resolution change function may refer to changing the size of the projection image. The resolution change function may include upscaling or downscaling.

After performing the correction function, at least one processor 111 may control the projection unit 112 to output the projection image to the projection area. The output projection image may be a corrected image.

According to various embodiments, the electronic apparatus 100 may be implemented as a fixed projector rather than a mobile projector. The electronic apparatus 100 may be implemented in a form that does not include a movable member.

FIG. 2 is a block diagram for describing a specific configuration of the electronic apparatus 100 of FIG. 1 according to an embodiment.

Referring to FIG. 2, the electronic apparatus 100 may include at least one of at least one processor 111, a projection unit 112, a memory 113, a communication interface 114, a manipulation interface 115, an input/output interface 116, a speaker 117, a microphone 118, a power supply unit 119, a driving unit 120, a sensor unit 121, or a moving member 122.

The components illustrated in FIG. 2 are merely various embodiments, and some components may be omitted, and new components may be added.

Contents already described in FIG. 1 are omitted.

At least one processor 111 may be implemented by a digital signal processor (DSP), a microprocessor, or a time controller (TCON) that processes a digital signal. However, the processor 120 is not limited thereto, but may include one or more of a central processing unit (CPU), a micro controller unit (MCU), a micro processing unit (MPU), a controller, an application processor (AP), a graphics-processing unit (GPU), a communication processor (CP), and an advanced reduced instruction set computer (RISC) machines (ARM) processor, or may be defined by these terms. At least one processor 111 may be implemented by a system-on-chip (SoC) or a large scale integration (LSI) in which a processing algorithm is embedded, or may be implemented in a field programmable gate array (FPGA) form. At least one processor 111 may perform various functions by executing computer executable instructions stored in the memory 113.

The projection unit 112 is a component that projects an image to the outside. According to various embodiments of the present disclosure, the projection unit 112 may be implemented with various projection methods (for example, a cathode-ray tube (CRT) method, a liquid crystal display (LCD) method, a digital light processing (DLP) method, a laser method, etc.). For example, the CRT method has the same principle as a CRT monitor. The CRT method displays an image on a screen by magnifying an image with a lens in front of a cathode-ray tube (CRT). Depending on the number of cathode-ray tubes, the CRT is divided into a single-tube type and a three-tube type. In the case of the three-tube type, red, green, and blue cathode-ray tubes may be implemented separately.

As another example, the LCD method is a method of displaying an image by transmitting light from a light source to a liquid crystal. The LCD method is divided into a single-plate type and a three-plate type. In the case of the three-plate type, light from a light source may be separated into red, green, and blue by a dichroic mirror (a mirror that reflects only a specific color of light and transmits the rest), transmit the liquid crystal, and then focused back into a single point.

As another example, the DLP method is a method of displaying an image using a digital micromirror device (DMD) chip. The DLP type of projection unit may include a light source, a color wheel, a DMD chip, a projection lens, etc. Light output from the light source may be colored as it passes through a rotating color wheel. The light passing through the color wheel is input to the DMD chip. The DMD chip includes numerous micromirrors and reflects light input to the DMD chip. The projection lens may serve to magnify the light reflected from the DMD chip to the image size.

As another example, the laser method includes a diode pumped solid state (DPSSS) laser and a galvanometer. Lasers that output various colors use three DPSS lasers, one for each RGB color installed separately, and then employ special mirrors to overlap their optical axes. The galvanometer includes a mirror and a high-power motor to move a mirror at high speeds. For example, the galvanometer may rotate a mirror at up to 40 kHz/sec. The galvanometer is mounted according to a scan direction. Generally, since the projector performs planar scanning, the galvanometer may also be arranged separately along x and y axes.

The projection unit 112 may include various types of light sources. For example, the projection unit 112 may include at least one light source of a lamp, an LED, and a laser.

The projection unit 112 may output images with a 4:3 aspect ratio, a 5:4 aspect ratio, or a 16:9 wide aspect ratio, depending on the purpose of the electronic apparatus 100 or the user's settings, and may output images with various resolutions, such as WVGA (854*480), SVGA (800*600), XGA (1024*768), WXGA (1280*720), WXGA (1280*800), SXGA (1280*1024), UXGA (1600*1200), and Full HD (1920*1080), depending on the aspect ratio.

The projection unit 112 may perform various functions for adjusting the output image under the control of at least one processor 111. For example, the projection unit 112 may perform functions such as zoom, keystone, quick corner (4-corner) keystone, and lens shift.

Specifically, the projection unit 112 may magnify or reduce the image depending on the distance (projection distance) from the screen. In other words, the zoom function may be performed depending on the distance from the screen. In this case, the zoom function may include a hardware method that adjusts the screen size by moving the lens, a software method that adjusts the screen size by cropping the image, etc. When the zoom function is performed, the image focus needs to be adjusted. For example, the methods of adjusting a focus include manual focus, motorized focus, etc. The manual focus method refers to a method of manually adjusting a focus, while the motorized focus refers to a method in which the projector automatically focuses using a built-in motor when the zoom function is performed. When performing the zoom function, the projection unit 112 may provide a digital zoom function through software, and an optical zoom function that performs the zoom function by moving the lens through the driving unit 120.

The projection unit 112 may perform a keystone correction function. When the height is not suitable for frontal projection, the screen may be distorted upward or downward. The keystone correction function refers to a function of correcting the distorted screen. For example, when distortion occurs in a horizontal direction of the screen, horizontal keystone correction may be used, and when distortion occurs in a vertical direction of the screen, vertical keystone correction may be used. The quick corner (4-corner) keystone correction function is a function of correcting a screen when a center area of the screen is normal but corner areas are unbalanced. A lens shift function is a function that shifts an image as it is when the image extends beyond a screen.

The projection unit 112 may automatically analyze the ambient environment and projection environment without a user input to provide zoom/keystone/focus functions. Specifically, the projection unit 112 may automatically provide zoom/keystone/focus functions based on the distance between the electronic apparatus 100 and the screen detected by a sensor (depth camera, distance sensor, infrared sensor, light sensor, etc.), information about the space where the electronic apparatus 100 is currently positioned, information about the amount of ambient light, etc.

The projection unit 112 may provide a lighting function using a light source. In particular, the projection unit 112 may provide a lighting function by outputting a light source using an LED. According to various embodiments, the projection unit 112 may include one LED, and according to another embodiment, the electronic apparatus 100 may include multiple LEDs. Depending on the implementation example, the projection unit 112 may output a light source using a surface-emitting LED. The surface-emitting LED may mean an LED having a structure in which an optical sheet is arranged on the upper side of the LED so that the light source is evenly distributed and output. Specifically, when a light source is output through an LED, the light source may be evenly distributed through an optical sheet, and the light source distributed through the optical sheet may be incident on the display panel.

The projection unit 112 may provide a dimming function to adjust the intensity of the light source to the user. Specifically, when the user input for adjusting the intensity of the light source is received from the user through the manipulation interface 115 (e.g., a touch display button or dial), the projection unit 112 may control the LED to output the intensity of the light source corresponding to the received user input.

The projection unit 112 may provide the dimming function based on content analyzed by at least one processor 111 without the user input. Specifically, the projection unit 112 may control the LED to output the intensity of the light source based on information (e.g., content type, content brightness, etc.) about the currently provided content.

The projection unit 112 may control the color temperature under the control of at least one processor 111. At least one processor 111 may control the color temperature based on the content. Specifically, when the content is identified to be output, at least one processor 111 may obtain frame-by-frame color information of the content whose output has been determined. Then, at least one processor 111 may control the color temperature based on the obtained frame-by-frame color information. At least one processor 111 may obtain at least one primary color of the frame based on the frame-by-frame color information. Then, at least one processor 111 may adjust the color temperature based on the obtained one or more primary colors. For example, the color temperature that at least one processor 111 may adjust may be classified into a warm type or a cold type. It is assumed that a frame (hereinafter, output frame) to be output includes a scene where a fire has occurred. At least one processor 111 may identify (or obtain) that the primary color is red based on the color information included in the current output frame. In addition, at least one processor 111 may identify a color temperature corresponding to the identified primary color (red). The color temperature corresponding to red may be a warm type. At least one processor 111 may utilize an artificial intelligence model to obtain color information or a primary color of the frame. According to various embodiments, the artificial intelligence model may be stored in the electronic apparatus 100 (e.g., memory 113). According to other embodiments, the artificial intelligence model may be stored in the external server capable of communicating with the electronic apparatus 100.

The memory 113 may be implemented by an internal memory such as a read-only memory (ROM) (for example, an electrically erasable programmable read-only memory (EEPROM)), a random access memory (RAM), or the like, included in at least one processor 111 or be implemented by a memory separate from at least one processor 111. In this case, the memory 113 may be implemented in a form of a memory embedded in the electronic apparatus 100 or a form of a memory attachable to and detachable from the electronic apparatus 100, depending on a data storing purpose. For example, data for traveling the electronic apparatus 100 may be stored in the memory embedded in the electronic apparatus 100, and data for an extension function of the electronic apparatus 100 may be stored in the memory attachable to and detachable from the electronic apparatus 100.

The memory embedded in the electronic apparatus 100 may be implemented by at least one of a volatile memory (for example, a dynamic RAM (DRAM), a static RAM (SRAM), a synchronous dynamic RAM (SDRAM), or the like) or a non-volatile memory (for example, a one time programmable ROM (OTPROM), a programmable ROM (PROM), an erasable and programmable ROM (EPROM), an electrically erasable and programmable ROM (EEPROM), a mask ROM, a flash ROM, a flash memory (for example, a NAND flash, a NOR flash, or the like), a hard drive, or a solid state drive (SSD)), and the memory attachable to and detachable from the electronic apparatus 100 may be implemented in a form such as a memory card (for example, a compact flash (CF), a secure digital (SD), a micro-SD, a mini-SD, an extreme digital (xD), a multi-media card (MMC), or the like), an external memory (for example, a universal serial bus (USB) memory) connectable to a USB port, or the like.

At least one command related to the electronic apparatus 100 may be stored in the memory 113. The memory 113 may store an operating system (O/S) for traveling the electronic apparatus 100. The memory 113 may store various software programs or applications for operating the electronic apparatus 100 according to various embodiments of the present disclosure. The memory 113 may include a semiconductor memory such as a flash memory, or a magnetic storage medium such as a hard disk, or the like.

Specifically, various software modules for operating the electronic apparatus 100 according to various embodiments of the present disclosure may be stored in the memory 113, and at least one processor 111 may execute various software modules stored in the memory 113 to control the operation of the computing device 100. That is, the memory 113 is accessed by at least one processor 111, and readout/recording/correction/deletion/update, and the like, of data in the memory 110 may be performed by at least one processor 111.

In the present disclosure, the term ‘memory’ may be used as meaning including the memory 113, a ROM (not illustrated) in at least one processor 111, a RAM (not illustrated), or a memory card (for example, a micro secure digital (SD) card or a memory stick) mounted in the electronic apparatus 100.

The communication interface 114 is a component performing communication with various types of external apparatuses depending on various types of communication manners. The communication interface 114 may include a wireless communication module or a wired communication module. Each communication module may be implemented in the form of at least one hardware chip.

The wireless communication module may be a module that wirelessly communicates with an external device. For example, the wireless communication module may include at least one of a Wi-Fi module, a Bluetooth module, an infrared communication module, or other communication modules.

The Wi-Fi module and the Bluetooth module may perform communication in the Wi-Fi method and the Bluetooth method, respectively. In the case of using the Wi-Fi module or the Bluetooth module, various connection information such as a service set identifier (SSID), a session key, and the like, is first transmitted and received, communication is connected using the connection information, and various information may then be transmitted and received.

The infrared communication module performs communication according to an infrared data association (IrDA) technology of wirelessly transmitting data to a short distance using an infrared ray disposed between a visible ray and a millimeter wave.

Other wireless communication modules may include at least one communication chip performing communication according to various wireless communication standards such as zigbee, 3^{rd} generation (3G), 3^{rd} generation partnership project (3GPP), long term evolution (LTE), LTE advanced (LTE-A), 4^{th} generation (4G), 5^{th} generation (5G), and the like, in addition to the communication manner described above.

The wired communication module may be a module that communicates with an external device in a wired manner. For example, the wired communication module may include at least one of a local area network (LAN) module, an Ethernet module, a pair cable, a coaxial cable, an optical fiber cable, or an ultra wide-band (UWB) module.

The manipulation interface 115 may include various types of input devices. For example, the manipulation interface 115 may include a physical button. In this case, the physical button may include a function key, a directional key (e.g., a four-way key), or a dial button. According to various embodiments, the physical button may be implemented as multiple keys. According to other embodiments, the physical button may be implemented as one key. When the physical button is implemented as one key, the electronic apparatus 100 may receive a user input in which one key is pressed for a threshold time or longer. When the user input in which one key is pressed for the threshold time or longer is received, at least one processor 111 may perform a function corresponding to the user input. For example, at least one processor 111 may provide a lighting function based on the user input.

The manipulation interface 115 may receive a user input using a non-contact method. When receiving a user input using a contact method, physical force should be transmitted to the electronic apparatus 100. Therefore, a method for controlling the electronic apparatus 100 regardless of physical force may be required. Specifically, the manipulation interface 115 may receive user gestures and perform operations corresponding to the received user gestures. The manipulation interface 115 may receive user gestures through a sensor (e.g., an image sensor or an infrared sensor).

The manipulation interface 115 may receive a user input using a touch method. For example, the manipulation interface 115 may receive a user input through a touch sensor. According to various embodiments, the touch method may be implemented in a non-contact manner. For example, the touch sensor may determine whether a user's body has approached within a threshold distance. The touch sensor may identify the user input even when the user does not make contact with the touch sensor. According to another implementation example, the touch sensor may identify the user input by a user touching the touch sensor.

The electronic apparatus 100 may receive the user input in various ways in addition to the above-described manipulation interface 115. In various embodiments, the electronic apparatus 100 may receive the user input through an external remote control device. The external remote control device may be a remote control device corresponding to the electronic apparatus 100 (e.g., a dedicated control device for the electronic apparatus 100) or a user's portable communication device (e.g., a smartphone or wearable device). The user's portable communication device may store an application for controlling the electronic apparatus 100. The portable communication device may obtain the user input through the stored application and transmit the obtained user input to the electronic apparatus 100. The electronic apparatus 100 may receive the user input from the portable communication device and perform an operation corresponding to the user's control command.

The electronic apparatus 100 may receive the user input using voice recognition. According to various embodiments, the electronic apparatus 100 may receive a user voice through a microphone included in the electronic apparatus 100. According to other embodiments, the electronic apparatus 100 may receive a user voice from a microphone or an external device. Specifically, the external device may obtain a user voice through a microphone of the external device and transmit the obtained user voice to the electronic apparatus 100. The user voice transmitted from the external device may be audio data or digital data (e.g., audio data converted into a frequency domain, etc.) converted from audio data. The electronic apparatus 100 may perform an operation corresponding to the received user voice. Specifically, the electronic apparatus 100 may receive the audio data corresponding to the user voice through the microphone. Then, the electronic apparatus 100 may convert the received audio data into the digital data. Then, the electronic apparatus 100 may convert the converted digital data into text data using a speech to text (STT) function. According to various embodiments, the STT function may be performed directly on the electronic apparatus 100.

According to other embodiments, the STT function may be performed on the external server. The electronic apparatus 100 may transmit the digital data to the external server. The external server may convert the digital data into the text data and obtain control command data based on the converted text data. The external server may transmit the control command data (which may also include text data) to the electronic apparatus 100. The electronic apparatus 100 may perform an operation corresponding to the user voice based on the obtained control command data.

The electronic apparatus 100 may provide a voice recognition function using a single assistant (or an artificial intelligence assistant, such as Bixby. etc.) However, these are merely various embodiments, and a voice recognition function may be provided through multiple assistants. In this case, the electronic apparatus 100 may provide a voice recognition function by selecting one of multiple assistants based on a trigger word corresponding to the assistant or a specific key present on the remote control.

The electronic apparatus 100 may receive the user input using screen interaction. The screen interaction may refer to a function of identifying whether a predetermined event occurs through an image projected by the electronic apparatus 100 on a screen (or projection surface) and obtaining the user input based on the predetermined event. The predetermined event may refer to an event in which a predetermined object is identified at a specific position (e.g., a position where a UI for receiving the user input is projected). The predetermined object may include at least one of part (e.g., a finger) of the user's body, a pointer, or a laser point. When the predetermined object is identified at the position corresponding to the projected UI, the electronic apparatus 100 may identify that the user input for selecting the projected UI has been received. For example, the electronic apparatus 100 may project a guide image to display a UI on the screen. Then, the electronic apparatus 100 may identify whether the user selects the projected UI. Specifically, the electronic apparatus 100 may identify that the user has selected the projected UI when the predetermined event is identified at the position of the projected UI. The projected UI may include at least one item. The electronic apparatus 100 may perform spatial analysis to identify whether the predetermined event is at the position of the projected UI. The electronic apparatus 100 may perform spatial analysis through a sensor (e.g., an image sensor, an infrared sensor, a depth camera, a distance sensor, etc.). By performing the spatial analysis, the electronic apparatus 100 may identify whether the predetermined event occurs at a specific position (position where the UI is projected). When it is identified that a predetermined event has occurred at a specific position (position where the UI is projected), the electronic apparatus 100 may identify that a user input for selecting a UI corresponding to a specific position is received.

The input/output interface 116 is configured to input/output at least one of an audio signal and an image signal. The input/output interface 116 may receive at least one of an audio signal and an image signal from an external device and output control commands to the external device.

According to the implementation example, the input/output interface 116 may be implemented as an interface that inputs/outputs only the audio signal and an interface that inputs/outputs only the image signal, or implemented as a single interface that inputs/outputs both the audio signal and image signal.

According to various embodiments of the present disclosure, the input/output interface 116 may be implemented as a wired input/output interface of at least one of a high definition multimedia interface (HDMI), a mobile high-definition link (MHL), a universal serial bus (USB), a USB C-type, a display port (DP), Thunderbolt, a video graphics array (VGA) port, an RGB port, a D-subminiature (D-SUB), and a digital visual interface (DVI). According to various embodiments, the wired input/output interface may be implemented as an interface that inputs/outputs only the audio signal and an interface that inputs/outputs only the image signal, or implemented as a single interface that inputs/outputs both the audio signal and image signal.

The electronic apparatus 100 may receive data through the wired input/output interface, which is merely various embodiments, and may be supplied with power through the wired input/output interface. For example, the electronic apparatus 100 may be supplied with power from an external battery via the USB C-type or power from an outlet via a power adapter. As another example, the electronic apparatus 100 may be supplied with power from an external device (e.g., a laptop, a monitor, etc.) via a DP.

The electronic apparatus 100 may be configured such that the audio signal is input through the wired input/output interface, and the image signal is input through the wireless input/output interface (or communication interface). Alternatively, the electronic apparatus 100 may be configured such that the audio signal is input through the wireless input/output interface (or communication interface), and the image signal is input through the wired input/output interface.

The speaker 117 is a component that outputs audio signals. In particular, the speaker 117 may include an audio output mixer, an audio signal processor, and an acoustic output module. The audio output mixer may synthesize multiple audio signals to be output into at least one audio signal. For example, the audio output mixer may synthesize an analog audio signal and another analog audio signal (e.g., an analog audio signal received from an external source) into at least one analog audio signal. The acoustic output module may include a speaker or an output terminal. According to various embodiments, the acoustic output module may include multiple speakers. In this case, the acoustic output module may be arranged inside a main body, and sound emitted by covering at least a portion of a diaphragm of the acoustic output module may pass through a waveguide and be transmitted to the outside of the main body. The acoustic output module includes multiple audio output units, and the multiple audio output units are arranged symmetrically on the exterior of the main body, thereby emitting sound in all directions, i.e., 360°.

The microphone 118 is a component for receiving the user voice or other sounds and converting the user voice or other sounds into audio data. The microphone 118 may receive the user voice in an activated state. For example, the microphone 118 may be formed integrally on an upper side or in a front direction, a side direction, etc., of the electronic apparatus 100. The microphone 118 may include various configurations such as a microphone that collects user voices in analog form, an amplifier circuit that amplifies the collected user voices, an A/D conversion circuit that samples the amplified user voices and converts the amplified user voices into digital signals, and a filter circuit that removes noise components from the converted digital signals.

The power supply unit 119 may be supplied with power from the outside and supply power to various components of the electronic apparatus 100. The power supply unit 119 according to various embodiments of the present disclosure may be supplied with power through various methods. In various embodiments, the power supply unit 119 may be supplied with power using a connector 130 as illustrated in FIG. 1. The power supply unit 119 may be supplied with power using a 220V DC power cord. However, the power supply unit 119 is not limited thereto, and may be supplied with power using a USB power cord or a wireless charging method.

The power supply unit 119 may be supplied with power using an internal battery or an external battery. The power supply unit 119 according to various embodiments of the present disclosure may be supplied with power through the internal battery. For example, the power supply unit 119 may charge the power of the internal battery using at least one of a 220V DC power cord, a USB power cord, and a USB C-Type power cord, and may be supplied with power through the charged internal battery. The power supply unit 119 according to various embodiments of the present disclosure may be supplied with power through the external battery. For example, when the electronic apparatus 100 is connected to the external battery through various wired communication methods such as a USB power cord, a USB C-Type power cord, or a socket home, the power supply unit 119 may be supplied with power through the external battery. That is, the power supply unit 119 may be supplied with power directly from the external battery, or may charge the internal battery through the external battery and then be supplied with power from the charged internal battery.

The power supply unit 119 according to the present disclosure may be supplied with power using at least one of the multiple power supply methods described above.

Regarding power consumption, the electronic apparatus 100 may have power consumption of less than a preset value (e.g., 43 W) due to factors such as the socket type and other standards. In this case, the electronic apparatus 100 may vary power consumption to reduce power consumption when using a battery. That is, the electronic apparatus 100 may vary power consumption based on the power supply method, power usage, etc.

The driving unit 120 may drive at least one hardware component included in the electronic apparatus 100. The driving unit 120 may generate physical force and transmit the physical force to at least one hardware component included in the electronic apparatus 100.

The driving unit 120 may generate driving power for the movement of hardware components included in the electronic apparatus 100 (e.g., movement of the electronic apparatus 100) or rotation of the components (e.g., rotation of the projection lens).

The driving unit 120 may adjust the projection direction (or projection angle) of the projection unit 112. The driving unit 120 may move the position of the electronic apparatus 100. The driving unit 120 may control the moving member to move the electronic apparatus 100. For example, the driving unit 120 may control the moving member using the motor.

The sensor unit 121 may include at least one sensor. Specifically, the sensor unit 121 may include at least one of a tilt sensor for sensing a tilt of the electronic apparatus 100 and an image sensor for capturing an image. The tilt sensor may be an acceleration sensor or a gyro sensor, and the image sensor may refer to a camera or a depth camera. The tilt sensor may be described as a motion sensor. The sensor unit 121 may include various sensors in addition to the tilt sensor or the image sensor. For example, the sensor unit 121 may include an illuminance sensor and a distance sensor. The distance sensor may be a time of flight (ToF). The sensor unit 121 may include a LiDAR sensor.

The electronic apparatus 100 may control a lighting function in conjunction with an external device. Specifically, the electronic apparatus 100 may receive lighting information from the external device. The lighting information may include at least one of brightness information and color temperature information set by the external device. The external device may refer to a device (e.g., an IoT device included in the same home/work network) connected to the same network as the electronic apparatus 100 or may refer to a device (for example, a remote control server) that is not on the same network as the electronic apparatus 100 but is capable of communicating with the electronic apparatus 100. For example, it is assumed that an external lighting device (IoT device) included in the same network as the electronic apparatus 100 is outputting red light at a brightness of 50. The external lighting device (IoT device) may directly or indirectly transmit lighting information (e.g., information representing that it is outputting red light at a brightness of 50) to the electronic apparatus 100. The electronic apparatus 100 may control the output of the light source based on the lighting information received from the external lighting device. For example, when the lighting information received from the external lighting device includes information representing that red light is output at a brightness of 50, the electronic apparatus 100 may output red light at a brightness of 50.

The electronic apparatus 100 may control the lighting function based on biometric information. Specifically, at least one processor 111 may obtain user's biometric information. The biometric information may include at least one of user's body temperature, heart rate, blood pressure, respiration, and electrocardiogram. The biometric information may include various information in addition to the information described above. For example, the electronic apparatus 100 may include a sensor for measuring biometric information. At least one processor 111 may obtain the user's biometric information through the sensor and control the output of the light source based on the obtained biometric information. As another example, at least one processor 111 may receive the biometric information from an external device via the input/output interface 116. The external device may refer to the user's portable communication device (e.g., a smartphone or a wearable device). At least one processor 111 may obtain the user's biometric information from the external device and control the output of the light source based on the obtained biometric information. According to an implementation example, the electronic apparatus 100 may identify whether the user is sleeping, and when the user is identified as sleeping (or preparing for sleep), at least one processor 111 may control the output of the light source based on the user's biometric information.

The electronic apparatus 100 according to various embodiments of the present disclosure may provide various smart functions.

Specifically, the electronic apparatus 100 is connected to a portable terminal device for controlling the electronic apparatus 100, and the screen output from the electronic apparatus 100 may be controlled through the user input that is input from the portable terminal device. As an example, the portable terminal device may be implemented as a smartphone including a touch display, and the electronic apparatus 100 receives and outputs screen data provided by the portable terminal device from the portable terminal device, and the screen output from the electronic apparatus 100 may be controlled according to the user input that is input from the portable terminal device.

The electronic apparatus 100 may be connected to a mobile terminal device via various communication methods, such as Miracast, Airplay, wireless DEX, and Remote PC, thereby sharing content or music provided by the mobile terminal device.

The mobile terminal device and the electronic apparatus 100 may be connected via various connection methods. In various embodiments, the mobile terminal device may search for the electronic apparatus 100 to perform a wireless connection, or the electronic apparatus 100 may search for the mobile terminal device to perform a wireless connection. Furthermore, the electronic apparatus 100 may output content provided by the mobile terminal device.

In various embodiments, in a state in which the mobile terminal device is currently outputting specific content or music, when the mobile terminal device may be placed near the electronic apparatus 100 and then a preset gesture (e.g., a motion tap view) is detected on the display of the mobile terminal device, the electronic apparatus 100 may output the content or music being output by the mobile terminal device.

In various embodiments, the mobile terminal device comes closer to the electronic apparatus 100 to a preset distance or less (e.g., a non-contact tap view) or the mobile terminal device comes into contact with the electronic apparatus 100 twice within a short interval (e.g., a contact tap view) while the mobile terminal device is outputting specific content or music, the electronic apparatus 100 may output the content or music being output on the mobile terminal device.

The above-described embodiments described that the electronic apparatus 100 provides a screen identical to the screen provided by the mobile terminal device. However, the present disclosure is not limited thereto. That is, when a connection is established between the mobile terminal device and the electronic apparatus 100, the mobile terminal device may output a first screen provided by the mobile terminal device, and the electronic apparatus 100 may output a second screen provided by the mobile terminal device, which is different from the first screen. For example, the first screen may be a screen provided by a first application installed on the mobile terminal device, and the second screen may be a screen provided by a second application installed on the mobile terminal device. For example, the first screen and the second screen may be different screens provided by a single application installed on the mobile terminal device. For example, the first screen may include a remote control-style UI for controlling the second screen.

The electronic apparatus 100 according to the present disclosure may output a standby screen. For example, when the electronic apparatus 100 is not connected to an external device or when no input is received from the external device for a preset period of time, the electronic apparatus 100 may output the standby screen. The conditions for the electronic apparatus 100 to output the standby screen are not limited to the examples described above, and the standby screen may be output under various conditions.

The electronic apparatus 100 may output the standby screen in the form of a blue screen, but the present disclosure is not limited thereto. For example, the electronic apparatus 100 may extract only the shape of a specific object from data received from an external device to obtain an amorphous object, and output the standby screen including the obtained amorphous object.

The electronic apparatus 100 may further include a display.

The display 140 may be implemented by various types of displays such as a liquid crystal display (LCD), an organic light emitting diode (OLED) display, a plasma display panel (PDP), and the like. A driving circuit, a backlight unit, and the like, that may be implemented in a form such as an amorphous silicon thin film transistor (a-si TFT), a low temperature poly silicon (LTPS) TFT, an organic TFT (OTFT), and the like, may be included in the display. The display may be implemented as a touch screen coupled with a touch sensor, a flexible display, a three-dimensional display (3D display), etc. According to various embodiments of the present disclosure, the display may include not only a display panel that outputs an image, but also a bezel that houses the display panel. In particular, according to various embodiments of the present disclosure, the bezel may include a touch sensor for detecting user interaction.

The electronic apparatus 100 may further include a shutter unit.

The shutter unit may include at least one of a shutter, a fixing member, a rail, or a body.

The shutter may block light output from the projection unit 112. The fixing member may fix the position of the shutter. The rail may be a path for moving the shutter and the fixed member. The body may be a structure including the shutter and the fixed member.

The moving member 122 may refer to a member for moving from the first position to the second position in the space where the electronic apparatus 100 is arranged. The electronic apparatus 100 may control the moving member 122 to move the electronic apparatus 100 using the force generated by the driving unit 120. The electronic apparatus 100 may generate force to be transmitted to the moving member 122 using the motor included in the driving unit 120.

The moving member 122 may include at least one wheel (e.g., a circular wheel). The electronic apparatus 100 may move to a target position (or designated position) via the moving member. When the user input or control command is received, the electronic apparatus 100 may rotate the moving member by transmitting force generated through the motor to the moving member. The electronic apparatus 100 may control the moving member to adjust a rotation speed, a rotation direction, etc. The electronic apparatus 100 may perform a movement operation (or movement function) by controlling the moving member based on the target position, a direction of travel, etc.

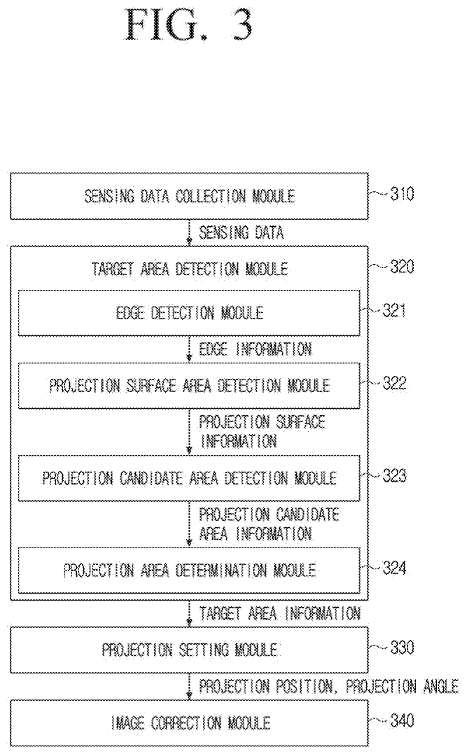

FIG. 3 is a diagram for describing an image projection process according to an embodiment.

Referring to FIG. 3, the electronic apparatus 100 may include at least one of a sensing data collection module 310, a projection area detection module 320, a projection setting module 330, and an image correction module 340.

The sensing data collection module 310 may obtain the sensing data. The sensing data may include at least one of the captured image and the depth information. The captured image may be received through the image sensor. The depth information may be received through a depth sensor. The sensing data collection module 310 may transmit the sensing data to the projection area detection module 321.

The sensing data collection module 310 may obtain at least one of spatial sensing data and device information. The spatial sensing data may include at least one of an RGB image or distance data. The device information may include at least one of pose information or acceleration information of the electronic apparatus 100.

The sensing data collection module 310 may obtain at least one of an RGB image of a space, a distance value between the projection surface 10 and the electronic apparatus 100, and the sensing data from an acceleration sensor.

For example, the sensing data collection module 310 may obtain the sensing data at a single fixed position. The sensing data collection module 310 may obtain the sensing data while rotating the electronic apparatus 100 in the z-axis direction at a single fixed position.

For example, the sensing data collection module 310 may obtain the sensing data while moving in a space within a preset range.

The projection area detection module 320 may detect the projection area based on the sensing data collected (or obtained) by the sensing data collection module 310. The projection area may include the area to which the projection image is output.

The projection area detection module 320 may include at least one of an edge detection module 321, a projection surface area detection module 322, a projection candidate area detection module 323, and a projection area determination module 324.

The edge detection module 321 may detect (or extract) an outline (or contour) from the captured image. The edge detection module 321 may generate the edge information based on the captured image. The edge detection module 321 may generate the edge information based on the captured image received from the sensing data collection module 310. The edge detection module 321 may transmit the edge information to the projection surface area detection module 322.

The edge detection module 321 may be implemented as an artificial intelligence model. The edge detection module 321 may include a DNN model.

The projection surface area detection module 322 may identify the projection surface based on the edge information. The projection surface area detection module 322 may segment multiple areas based on the outline included in the edge information. The projection surface area detection module 322 may identify the projection surface capable of outputting the projection image from among the multiple areas. The projection surface may be described as the projection surface area. The projection surface area detection module 322 may transmit information about the projection surface to the projection candidate area detection module 323.

The projection surface area detection module 322 may obtain characteristic information about a projectable surface. The characteristic information may include at least one of the position of the projection surface, the degree of rotation of the projection surface, and the degree of tilt of the projection surface.

The projection surface area detection module 322 may re-perform a scanning operation when the projection surface (or projection surface area) is not identified.

The projection surface area detection module 322 may perform an operation using a recently used projection surface area when the projection surface (or projection surface area) is not identified.

The projection surface area detection module 322 may perform a plane segmentation function.

The projection candidate area detection module 323 may identify the projection candidate area, which is an area to which the projection image is to be output. The projection candidate area may be described as a candidate projection area, a preliminary projection area, projection preliminary area, etc. The projection candidate area detection module 323 may identify the projection candidate area to which the projection image may be output from among the projection surfaces. The projection candidate area detection module 323 may transmit the information about the projection candidate area to the projection area determination module 324.

The projection surface may represent an entire segmented area.

The projection candidate area may represent the area on the projection surface where the projection image is actually output.

The projection candidate area detection module 323 may receive the information about the projection surface area and the depth information obtained by performing the plane segmentation function. The projection candidate area detection module 323 may merge (or map) the distance data included in the information about the projection surface area and the depth information.

The projection candidate area detection module 323 may obtain a tilt angle for each plane. The projection candidate area detection module 323 may calculate the angle of the bottom surface of the electronic apparatus 100 based on the gravity direction obtained from the acceleration sensor.

The projection candidate area detection module 323 may identify a projection candidate area having a maximum size based on the calculated angle of the bottom surface of the electronic apparatus 100, the tilt angle for each plane, and the preset resolution.

The projection area determination module 324 may determine the projection area for outputting the projection image based on the information about the projection candidate area. The projection area determination module 324 may determine the projection area based on at least one of the content type, the gaze direction of the user object, the content information, and the projection method (normal projection, ultra-short throw).

For example, there may be multiple projection candidate areas and a single projection area.

For example, there may be one projection candidate area and one projection area.

The projection area determination module 324 may determine the projection area based on at least one of the size of the projection candidate area, the position of the projection candidate area, the user's gaze direction, and the content information.

The projection area determination module 324 may perform an image correction function in consideration of the characteristic information of the projection surface and the optical characteristic information of the electronic apparatus 100. The optical characteristics of the electronic apparatus 100 may include information indicating the physical characteristics of the projection unit 112.

The projection area determination module 324 may transmit the determined target area information to the projection setting module. The target area information may be described as the information about the projection area.

The projection setting module 330 may apply settings related to the projection function based on the information about the projection area. The operation of applying the settings may include an operation of determining and applying at least one of the projection position and the projection angle. The projection setting module 330 may transmit at least one of the projection position and the projection angle to the image correction module 340.

The image correction module 340 may perform an image correction function based on at least one of the projection position and the projection angle. The image correction function may include performing a keystone correction function, a leveling correction function, and a resolution change function.

The keystone correction may refer to an operation of correcting a trapezoidal image into a rectangular shape. The leveling function may refer to a function of rotating an image. The resolution change function may refer to changing the size of the projection image. The resolution change function may include upscaling or downscaling.

FIG. 4 is a diagram for describing a captured image according to an embodiment.

Referring to FIG. 4, the electronic apparatus 100 may obtain the captured image 400. The electronic apparatus 100 may obtain a captured image 400 through the sensor unit 121. The electronic apparatus 100 may analyze the captured image 400 to identify the projection surface 10.

The projection surface 10 may be segmented into a first area 411, a second area 412, a third area 413, and a fourth area 414. It is assumed that the first area 411 and the fourth area 414 have a check pattern, and the second area 412 and the fourth area 414 does not have a pattern. The electronic apparatus 100 may identify the projection surface 10 including four areas. Each area may be described as the projection surface area.

FIG. 5 is a diagram for describing depth information according to an embodiment.

Referring to FIG. 5, the electronic apparatus 100 may obtain the depth information 500. The electronic apparatus 100 may obtain the depth information 500 using the distance sensor included in the sensor unit 121. The depth information may be described as a depth image, depth data, distance data, distance information, etc. The distance sensor may include at least one of a distance camera, a depth sensor, and a depth camera. The depth information 500 may be an image indicating the distance (or depth) of each pixel included in the captured image with respect to the sensing position.

The electronic apparatus 100 may obtain depth information 510 in different ways. The depth information 510 may be a sparsely displayed image indicating the distance corresponding to each pixel. The depth information 510 may represent the sparse depth map.

FIG. 6 is a diagram for describing the edge information according to an embodiment.

Referring to FIG. 6, the electronic apparatus 100 may obtain edge information 600. The electronic apparatus 100 may obtain the edge information 600 based on the captured image of the projection surface 10.

The edge information may include information extracted from only the outline (or contour) of at least one object included in the captured image. The edge information may be described as an edge map, edge data, edge map information, an edge image, etc.

The electronic apparatus 100 may obtain the edge information 600 by extracting the outline of at least one object included in the captured image 400 of FIG. 5.

For example, the electronic apparatus 100 may obtain the edge information 600 by extracting the outline of the projection surface 10 included in the captured image 400 of FIG. 5.

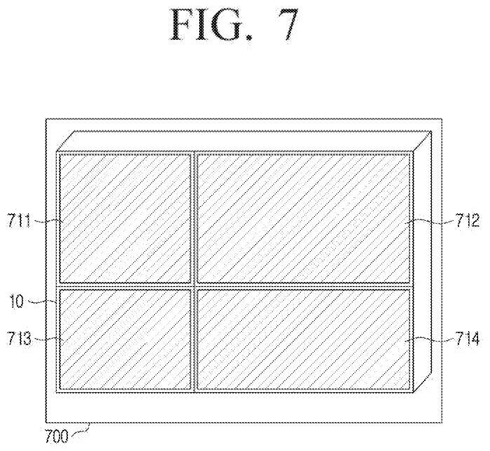

FIG. 7 is a diagram for describing the projection surface according to an embodiment.

Referring to FIG. 7, the electronic apparatus 100 may identify the projection surface area based on the edge information 600. The electronic apparatus 100 may obtain projection surface area information 700.

The projection surface area may include an area including a plane greater than or equal to a threshold width. The electronic apparatus 100 may identify an area having a plane greater than or equal to a threshold width in the edge information as the projection surface area. The threshold area may be determined based on at least one of the user setting, the content size, or the position of the electronic apparatus 100.

The electronic apparatus 100 may identify an area representing at least one plane from the edge information 600. The electronic apparatus 100 may determine an area having a width greater than or equal to the threshold width as the projection surface area.

The electronic apparatus 100 may identify multiple areas representing the plane. The electronic apparatus 100 may determine an area having a width greater than or equal to a threshold width from among the multiple areas as the projection surface area.

The electronic apparatus 100 may identify a first projection surface area 711, a second projection surface area 712, a third projection surface area 713, and a fourth projection surface area 714 based on the edge information 600.

The electronic apparatus 100 may store information about the first projection surface area 711, information about the second projection surface area 712, information about the third projection surface area 713, and information about the fourth projection surface area 714. The projection surface area information may each include position information (or coordinate information) of the projection surface area.

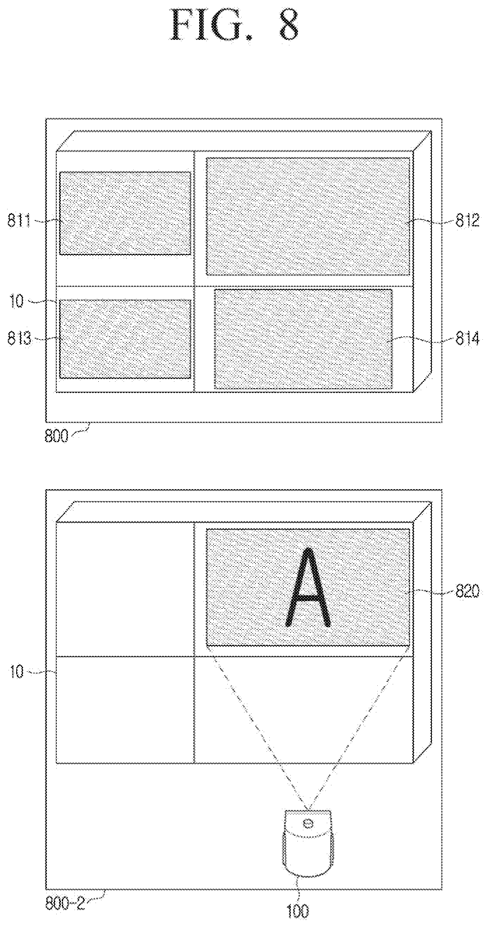

FIG. 8 is a diagram for describing the projection candidate area and the target area according to an embodiment.

Referring to FIG. 8, the electronic apparatus 100 may identify the projection candidate area based on the information about the projection surface area. The electronic apparatus 100 may obtain projection candidate area information 800.

The projection candidate area may include an area to which the projection image may be output. The information about the projection candidate area may include the position information (or coordinate information) about the area to which the projection image may actually be output.

The size of the projection surface area may be greater than or equal to the size of the projection candidate area. The projection surface area may represent all areas where projection itself is possible. The projection candidate area may represent an area defined so that the projection image may be output at an accurate position.

The electronic apparatus 100 may identify a first projection candidate area 811, a second projection candidate area 812, a third projection candidate area 813, and a fourth projection candidate area 814 based on the edge information 600 and the projection surface area information.

The electronic apparatus 100 may determine the projection candidate area based on at least one of the preset resolution, the current position of the electronic apparatus 100, and the projection ratio of the electronic apparatus 100.

According to various embodiments, the electronic apparatus 100 may determine the projection candidate area based on the preset resolution. The preset resolution may include aspect ratio information. It is assumed that the aspect ratio information is 16:9 (horizontal:vertical). The electronic apparatus 100 may identify an area to which a rectangular frame with a 16:9 ratio may be output at a maximum size as the projection candidate area from among the projection surface areas.

Referring to embodiment 800-2 of FIG. 8, the electronic apparatus 100 may determine one area as a target area from among the projection candidate areas. It is assumed that the second projection candidate area 812 is determined as the target area. The electronic apparatus 100 may output the projection image to the second projection candidate area 812.

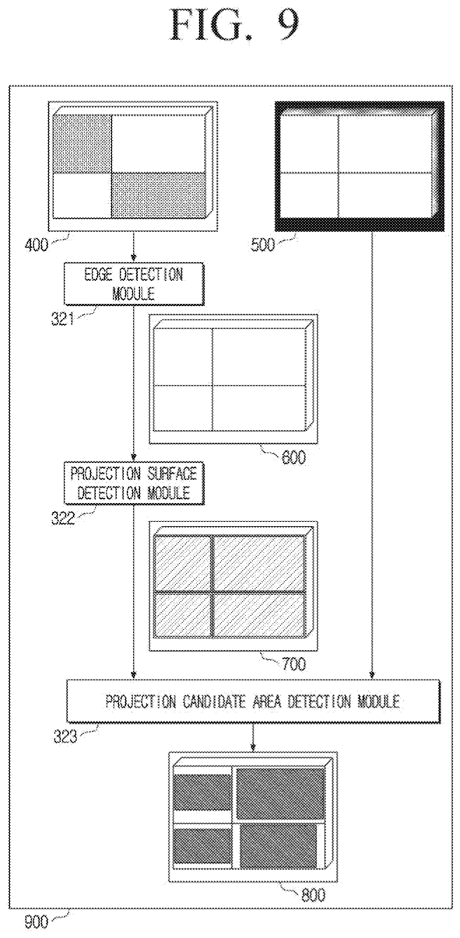

FIG. 9 is a diagram for describing an operation of acquiring the projection candidate area according to an embodiment.

Referring to embodiment 900 of FIG. 9, the electronic apparatus 100 may obtain the captured image 400. The electronic apparatus 100 may transmit the captured image 400 to the edge detection module 321. The electronic apparatus 100 may obtain the edge information 600 using the edge detection module 321. The electronic apparatus 100 may transmit the edge information 600 to the projection surface detection module 322.

The electronic apparatus 100 may obtain the projection surface area information 700 based on the projection surface detection module 322. The electronic apparatus 100 may transmit the projection surface area information 700 to the projection candidate area detection module 323.

The electronic apparatus 100 may obtain the projection candidate area information 800 based on the projection candidate area detection module 323.

The electronic apparatus 100 may obtain the depth information 500. The electronic apparatus 100 may transmit the depth information 500 to the projection candidate area detection module 323.

For example, the electronic apparatus 100 may obtain the projection candidate area information 800 based on the projection surface area information 700 and the depth information 500.

For example, the electronic apparatus 100 may obtain the projection candidate area information 800 based on the projection surface area information 700.

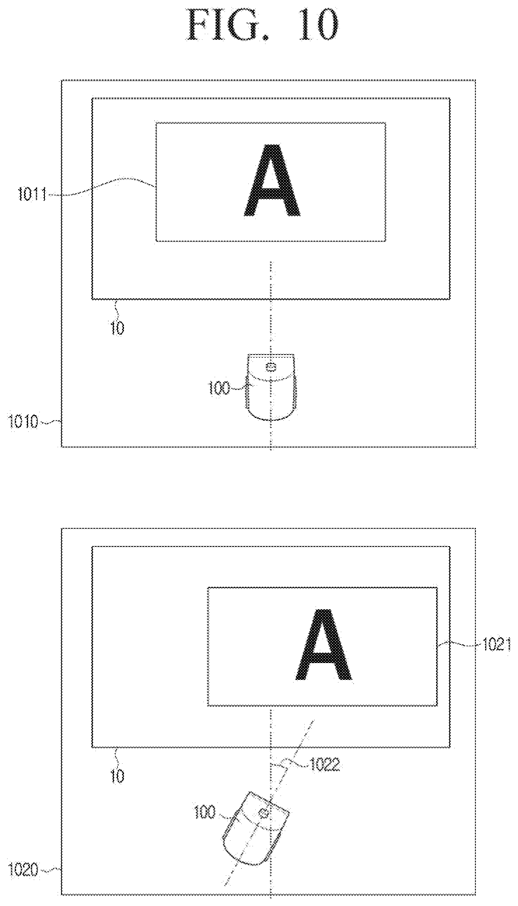

FIG. 10 is a diagram for describing a horizontal tilt according to an embodiment.

Referring to FIG. 10, according to embodiment 1010, the electronic apparatus 100 may output a projection image 1011 to the projection surface 10 in a horizontal projection direction. It is assumed that the horizontal tilt is 0. The horizontal tilt may refer to the degree to which the electronic apparatus 100 is tilted left or right toward the front.

According to embodiment 1020, the electronic apparatus 100 may output the projection image 1021 to the projection surface 10 in the horizontal projection direction. It is assumed that the horizontal tilt 1022 is 30°. When the horizontal tilt is 30° to the right, the electronic apparatus 100 may output the projection image 1021 to the right of the projection surface 10 by 30° to the right.

The horizontal tilt may represent a rotation angle (yaw) with respect to the z-axis of FIG. 13.

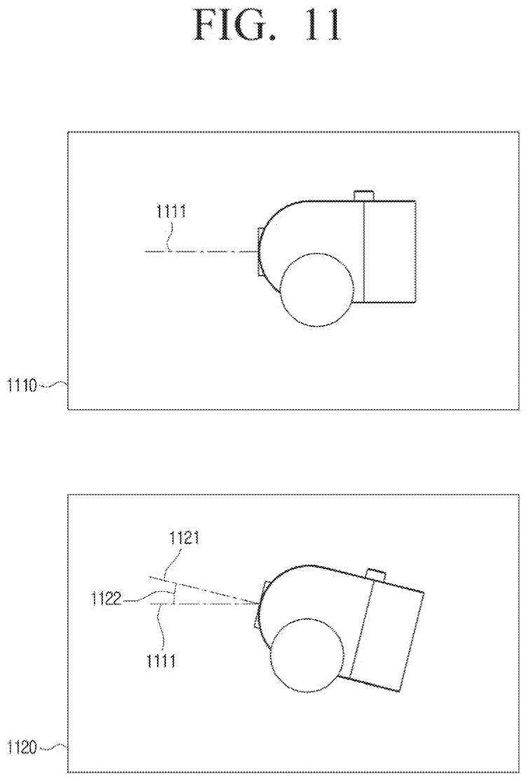

FIG. 11 is a diagram for describing a vertical tilt according to an embodiment.

Referring to FIG. 11, according to embodiment 1110, the electronic apparatus 100 may output the projection image to the projection surface in a horizontal projection direction. It is assumed that the vertical tilt is 0. The vertical tilt may refer to the degree to which the electronic apparatus 100 is tilted upward or downward toward the front. When the vertical tilt is 0, the projection image may be output horizontally. A virtual line 1111 representing the bottom surface and the virtual line 1111 along which the electronic apparatus 100 faces the front may be the same (or parallel).

According to embodiment 1120, the electronic apparatus 100 may output the projection image to the projection surface in the horizontal projection direction. It is assumed that a vertical tilt 1122 is 30°. When the vertical tilt is 30° upward, the electronic apparatus 100 may output the projection image upward by 30° on the projection surface. The virtual line 1111 representing the bottom surface and the virtual line 1121 along which the electronic apparatus 100 faces the front may not be parallel. The vertical tilt 1122 may represent the angle between the virtual line 1111 representing the bottom surface and the virtual line 1121 along which the electronic apparatus 100 faces the front.

The vertical tilt may represent a rotation angle (pitch) with respect to the z-axis of FIG. 13.

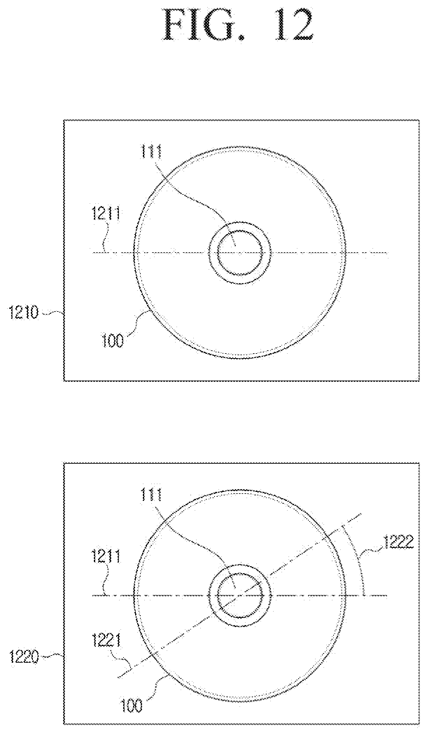

FIG. 12 is a diagram for describing horizontal distortion according to an embodiment.

Referring to FIG. 12, according to embodiment 1210, the electronic apparatus 100 may output the projection image without horizontal distortion. A reference without horizontal distortion is indicated by a horizontal line 1211. According to embodiment 1210, the reference horizontal line and the horizontal line of the electronic apparatus 100 may coincide.

According to embodiment 1220, the electronic apparatus 100 may have horizontal distortion 1222 of 30° to the right. The reference horizontal line 1211 and the horizontal line 1221 of the electronic apparatus may differ by the horizontal distortion 1222.

The horizontal distortion may represent a rotation angle (roll) with respect to the x-axis of FIG. 13.

FIG. 13 is a diagram for describing rotation information of the electronic apparatus 100 according to an embodiment.

FIG. 13 is a diagram for describing the horizontal distortion, the horizontal tilt, and the vertical tilt of the electronic apparatus 100.

Embodiment 1310 of FIG. 13 is a graph defining rotation directions along the x, y, and z axes. Rotation with respect to the x-axis may be defined as roll, rotation with respect to the y-axis may be defined as pitch, and rotation with respect to the z-axis may be defined as yaw.

Embodiment 1320 of FIG. 13 may describe the rotation direction of the projection surface 10 as the rotation direction defined in the embodiment 1310. The x-axis rotation information of the projection surface 10 may correspond to a roll rotation with respect to the x-axis of the projection surface 10. The y-axis rotation information of the projection surface 10 may correspond to a pitch rotation with respect to the y-axis of the projection surface 10. The z-axis rotation information of the projection surface 10 may correspond to a yaw rotating with respect to the z-axis of the projection surface 10.

The x-axis rotation information may be described as first-axis rotation information or horizontal distortion information. The y-axis rotation information may be described as second-axis rotation information or vertical tilt information. The z-axis rotation information may be described as third-axis rotation information or horizontal tilt information.

The sensor unit 121 may obtain status information of the electronic apparatus 100. The status information of the electronic apparatus 100 may refer to a rotational state of the electronic apparatus 100. The sensor unit 121 may include at least one of a gravity sensor, an acceleration sensor, or a gyro sensor. The x-axis rotation information of the electronic apparatus 100 and the y-axis rotation information of the electronic apparatus 100 may be determined based on the sensing data obtained through the sensor unit 121. However, it may be difficult to establish a specific standard for the z-axis rotation information of the electronic apparatus 100 unless it is based on east, west, south, or north. Therefore, the electronic apparatus 100 may consider the status information of the projection surface 10 without separately considering the z-axis rotation information of the electronic apparatus 100. Specifically, the electronic apparatus 100 may perform an image correction operation in consideration of the z-axis rotation information of the projection surface 10.

FIG. 14 is a diagram for describing the rotation information of the projection surface according to an embodiment.

Embodiment 1410 of FIG. 14 is a graph defining rotation directions along the x, y, and z axes. Rotation with respect to the x-axis may be defined as roll, rotation with respect to the y-axis may be defined as pitch, and rotation with respect to the z-axis may be defined as yaw.

Embodiment 1420 of FIG. 14 may describe the rotation direction of the projection surface 10 as the rotation direction defined in the embodiment 1410. The x-axis rotation information of the projection surface 10 may correspond to a roll rotation with respect to the x-axis of the projection surface 10. The y-axis rotation information of the projection surface 10 may correspond to a pitch rotation with respect to the y-axis of the projection surface 10. The z-axis rotation information of the projection surface 10 may correspond to a yaw rotating with respect to the z-axis of the projection surface 10.

The x-axis rotation information may be described as the first-axis rotation information. The y-axis rotation information may be described as second-axis rotation information. The z-axis rotation information may be described as third-axis rotation information.

FIG. 15 is a diagram for describing the z-axis rotation information of the projection surface according to an embodiment.

Embodiment 1510 of FIG. 15 is a view illustrating a state in which the electronic apparatus 100 outputs a projection image while the projection surface 10 is not rotated with respect to the z-axis, as viewed from above the electronic apparatus 100. It is assumed that the electronic apparatus 100 is placed on a table 20.

Embodiment 1520 of FIG. 15 is a view illustrating a state in which the electronic apparatus 100 outputs a projection image while the projection surface 10 rotates counterclockwise by a certain angle θ1 with respect to the z-axis, as viewed from above the electronic apparatus 100. It is assumed that the electronic apparatus 100 is placed on a table 20.

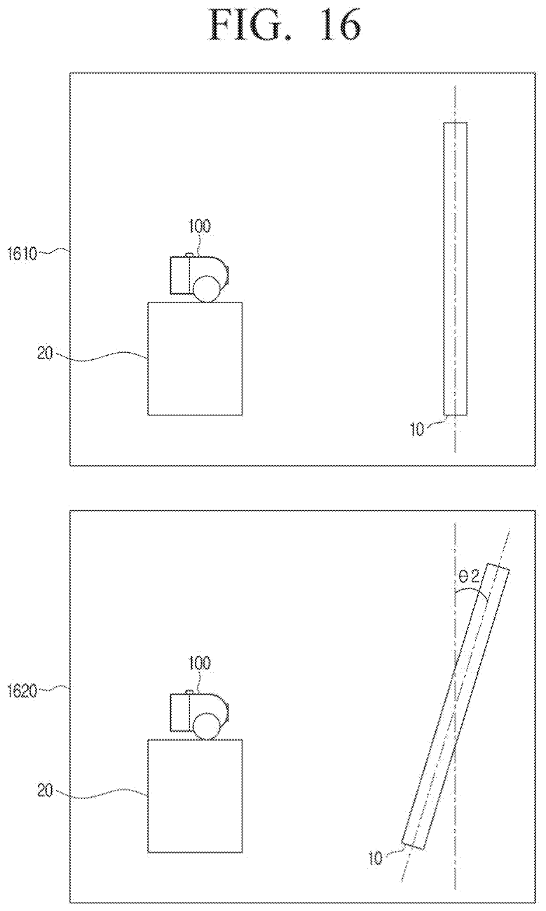

FIG. 16 is a diagram for describing y-axis rotation information of the projection surface according to an embodiment.

Referring to embodiment 1610 of FIG. 16, it illustrates a state in which the projection surface 10 is not rotated with respect to the y-axis.

Referring to embodiment 1620 of FIG. 16, it illustrates a state in which the projection surface 10 is rotated with respect to the y-axis. Specifically, it is assumed that the projection surface 10 is rotated by a predetermined angle θ2 with respect to the y-axis.

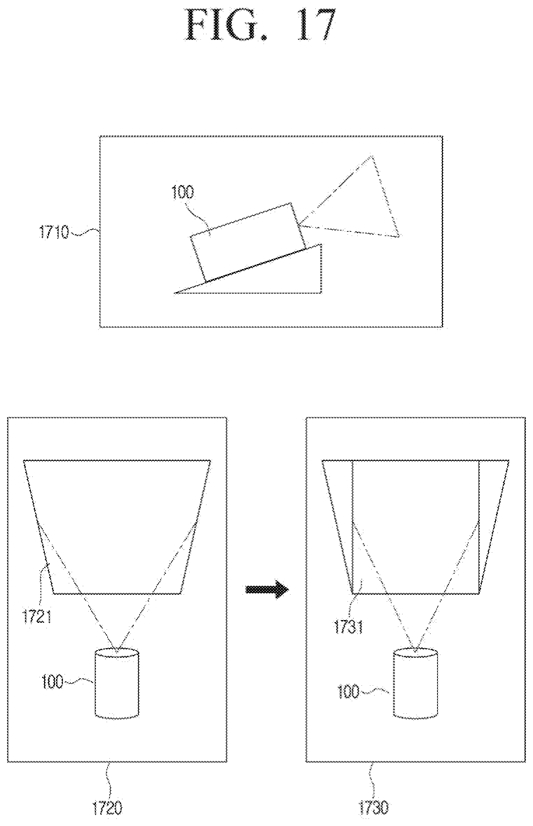

FIG. 17 is a diagram for describing an operation of performing the keystone function in consideration of the vertical tilt according to an embodiment.

Referring to embodiment 1710 of FIG. 17, the electronic apparatus 100 may output the projection image in a state in which there is the vertical tilt.

Referring to embodiment 1720, the electronic apparatus 100 may output a projection image 1721 while there is a vertical tilt. Due to the vertical tilt, the projection image 1721 may be output in a trapezoidal shape rather than a rectangle that is an original image shape. To address issues occurring from the presence of the horizontal tilt, the electronic apparatus 100 may perform the keystone function.

Referring to embodiment 1730, the electronic apparatus 100 may perform a keystone function to modify the original image so that the finally output projection image 1731 becomes rectangular.

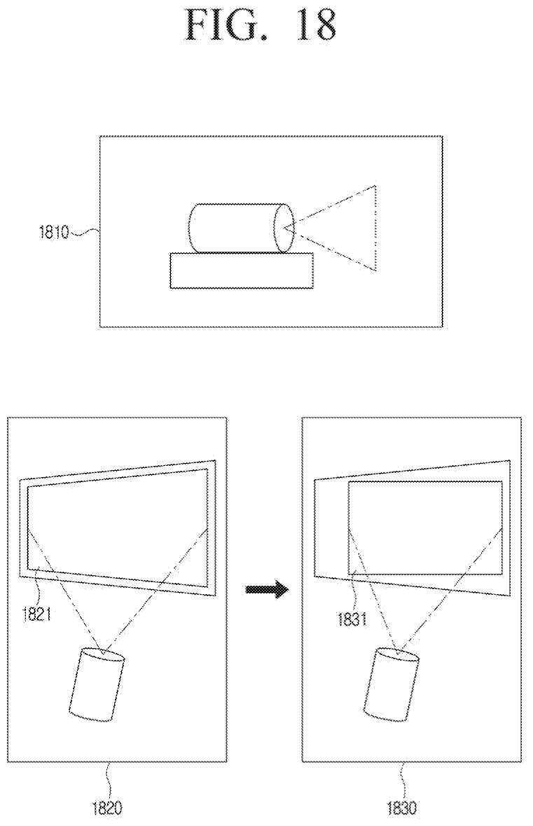

FIG. 18 is a diagram for describing an operation of performing the keystone function in consideration of the horizontal tilt according to an embodiment.

Referring to embodiment 1810 of FIG. 18, the electronic apparatus 100 may output the projection image in a state in which there is the horizontal tilt.

Referring to embodiment 1820, the electronic apparatus 100 may output a projection image 1821 while there is the horizontal tilt. Due to the horizontal tilt, the projection image 1821 may be output in a trapezoidal shape rather than a rectangle that is an original image shape. To address issues occurring from the presence of the horizontal tilt, the electronic apparatus 100 may perform the keystone function.

Referring to embodiment 1830, the electronic apparatus 100 may perform a keystone function to modify the original image so that the finally output projection image 1831 becomes rectangular.

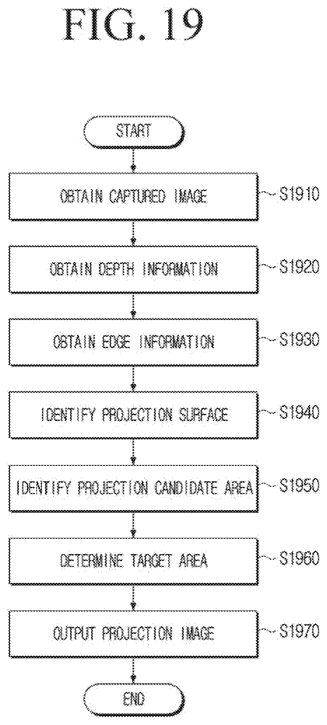

FIG. 19 is a diagram for describing an operation of outputting the projection image to the target area according to an embodiment.

Referring to FIG. 19, the electronic apparatus 100 may obtain the captured image (S1910). The electronic apparatus 100 may obtain the depth information (S1920). The electronic apparatus 100 may obtain the edge information based on the captured image (S1930).

The electronic apparatus 100 may identify the projection surface 10 (S1940). The electronic apparatus 100 may identify the projection surface 10 by identifying a plane having a size greater than or equal to a threshold size. The electronic apparatus 100 may identify the projection surface area.

The electronic apparatus 100 may identify the projection surface area (S1950). The projection candidate area may be included in the projection surface area.

The electronic apparatus 100 may determine the target area based on the projection candidate area (S1960). The electronic apparatus 100 may output the projection image to the target area (S1970).

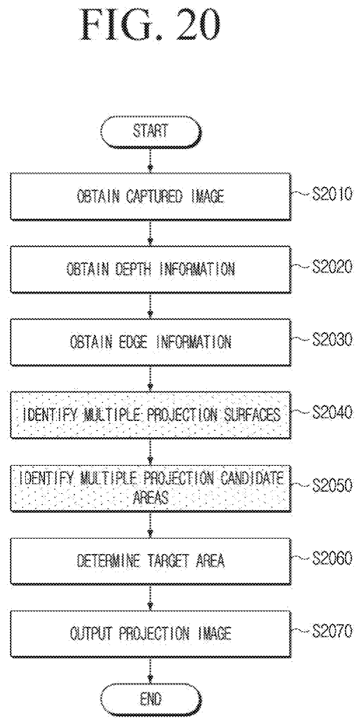

FIG. 20 is a diagram for describing an operation of identifying multiple projection candidate areas according to an embodiment.

This may correspond to operations S2010, S2020, S2030, S2060, and S2070 of FIG. 20. Duplicate descriptions will be omitted.

After obtaining the edge information, the electronic apparatus 100 may identify the multiple projection surfaces based on the edge information (S2040). The electronic apparatus 100 may identify the multiple projection surface areas.

The electronic apparatus 100 may identify the multiple projection candidate areas based on the multiple projection surfaces (or multiple projection surface areas) (S2050).

The electronic apparatus 100 may determine one of the multiple projection candidate areas as the target area. The electronic apparatus 100 may output the projection image to the target area.

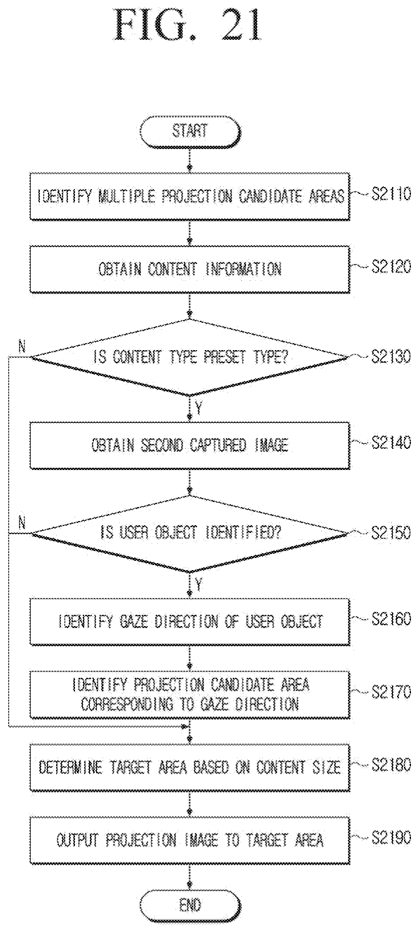

FIG. 21 is a diagram for describing an operation of determining the target area in consideration of the user's gaze direction according to an embodiment.

Operation S2110 of FIG. 21 may correspond to operation S2050 of FIG. 20. Duplicate descriptions will be omitted.

After identifying the multiple projection candidate areas, the electronic apparatus 100 may obtain content information (S2120). The content information may include metadata that may represent the content. The metadata may include at least one of a content name, a content type, a content time, and a content size.

The electronic apparatus 100 may determine whether the content type corresponds to a preset type (S2130).

When the content type is not a preset type (S2130-N), the electronic apparatus 100 may determine the target area based on the content size (S2180).

When the content type is a preset type (S2130-Y), the electronic apparatus 100 may obtain the captured image (S2140). The captured image obtained in operation S1910 of FIG. 19 may be described as the first captured image, and the captured image obtained in operation S2140 may be described as the second captured image.

The electronic apparatus 100 may determine whether a user object is identified based on the second captured image (S2150). The electronic apparatus 100 may identify whether an object representing a user is included in the second captured image.

When the second captured image does not include the user object (S2150-N), the electronic apparatus 100 may determine the target area based on the content size (S2180).

When the second captured image includes a user object (S2150-Y), the electronic apparatus 100 may identify the gaze direction of the user object (S2160).

The electronic apparatus 100 may identify the projection candidate area corresponding to the gaze direction of the user object (S2170). The electronic apparatus 100 may identify (or select) the area corresponding to the gaze direction from among the multiple projection candidate areas.

The electronic apparatus 100 may determine the target area from among the areas corresponding to the gaze direction based on the content size (S2180). The electronic apparatus 100 may determine an area capable of outputting the content size from among the projection candidate areas as the target area. When there are multiple areas capable of outputting the content size, the electronic apparatus 100 may determine the area with the largest area as the target area.

The electronic apparatus 100 may output the projection image to the target area (S2190).

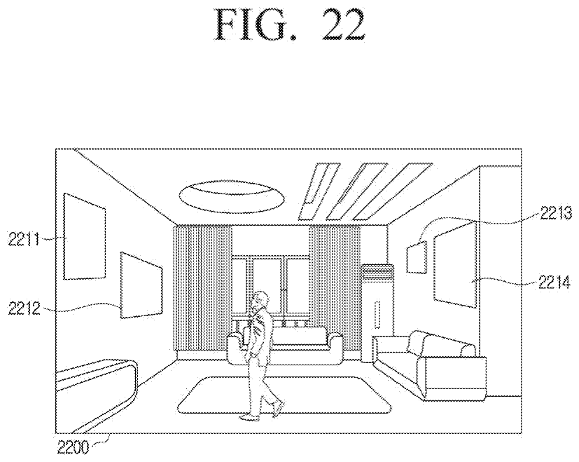

FIG. 22 is a diagram for describing an operation of determining the target area in consideration of the user's gaze direction according to an embodiment.

Referring to embodiment 2200 of FIG. 22, the electronic apparatus 100 may identify four projection candidate areas 2211, 2212, 2213, and 2214.

The electronic apparatus 100 may identify the user object based on the second captured image. The electronic apparatus 100 may identify the gaze direction of the user object. The electronic apparatus 100 may identify (or select) the projection candidate area 2211 and 2212 corresponding to the gaze direction from among the multiple projection candidate areas 2211, 2212, 2213, and 2214.

The electronic apparatus 100 may determine the target area from among the projection candidate areas 2211 and 2212 corresponding to the identified (or selected) gaze direction.

For example, the electronic apparatus 100 may determine the area with the largest area from among the multiple projection candidate areas 2211 and 2212 as the target area.

According to various embodiments, the electronic apparatus 100 may select the projection candidate area based on the projection method. The electronic apparatus 100 may output the projection image using a first projection method (normal projection method) or a second projection method (ultra-short throw method). There may be a first projection distance range required to output the projection image using the first projection method. There may be a second projection distance range required to output the projection image using the second projection method.

The electronic apparatus 100 may identify the projection method of the electronic apparatus 100. The electronic apparatus 100 may select the projection candidate area based on the projection distance range corresponding to the identified projection method.

For example, it is assumed that the projection method of the electronic apparatus 100 is the first projection method. The electronic apparatus 100 may exclude the projection candidate area that may not be output within the first projection distance range corresponding to the first projection method. The electronic apparatus 100 may select the projection candidate area that may be output within the first projection distance range.

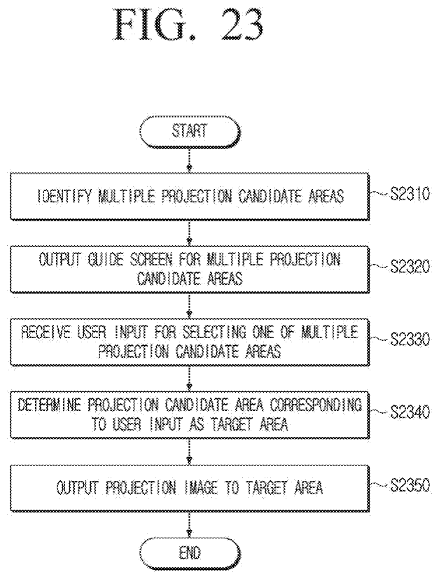

FIG. 23 is a diagram for describing an operation of determining the target area based on the user input according to an embodiment.

Referring to FIG. 23, the electronic apparatus 100 may identify the multiple projection candidate areas (S2310). Operation S2310 may correspond to operation S2050 of FIG. 20.

The electronic apparatus 100 may output a guide screen for the multiple projection candidate areas (S2320).

The electronic apparatus 100 may receive the user input for selecting one of the multiple projection candidate areas (S2330). The user input may include at least one of a command for inputting a specific button, a voice command, or a user gesture.

The electronic apparatus 100 may determine the projection candidate area corresponding to the user input as the target area (S2340). The electronic apparatus 100 may output the projection image to the target area.

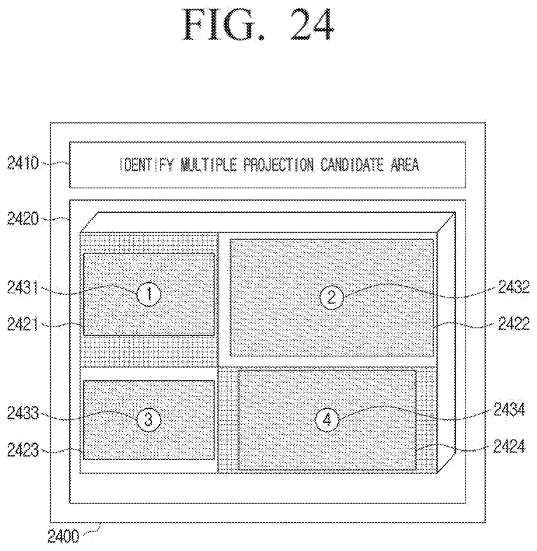

FIG. 24 is a diagram for describing the guide screen for selecting the target area according to an embodiment.

Referring to FIG. 24, when there are the multiple projection candidate areas, the electronic apparatus 100 may provide a guide screen 2400. The guide screen 2400 may include at least one of a UI 2410 including information requesting selection of one of the multiple projection candidate areas, and a UI 2420 representing the multiple projection candidate areas.

The UI 2420 may include at least one of a first projection candidate area 2421 and a GUI 2431 representing the first projection candidate area 2421.

The UI 2420 may include at least one of a second projection candidate area 2422 and a GUI 2432 representing the second projection candidate area 2422.

The UI 2420 may include at least one of a third projection candidate area 2423 and a GUI 2433 representing the third projection candidate area 2423.

The UI 2420 may include at least one of a fourth projection candidate area 2424 and a GUI 2434 representing the fourth projection candidate area 2424.

The GUI may represent a graphic user interface.

When the user input is received through the UI 2420, the electronic apparatus 100 may determine the area corresponding to the user input as the target area.

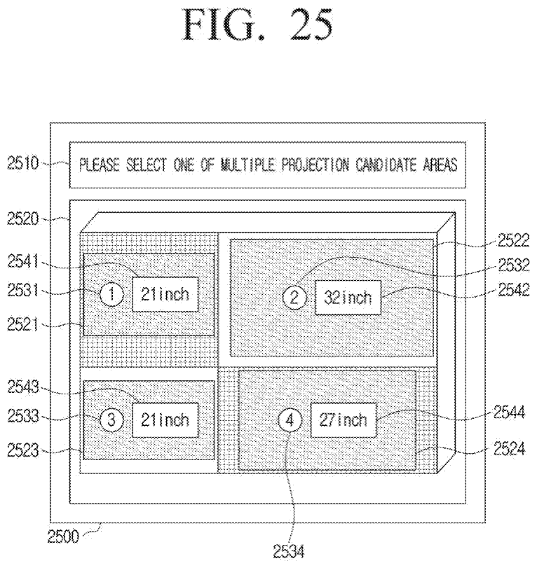

FIG. 25 is a diagram for describing the guide screen for selecting the target area according to an embodiment.

A guide screen 2500 of FIG. 25 may correspond to the guide screen 2400 of FIG. 24. A UI 2510 and a UI 2520 may correspond to the UI 2410 and the UI 2420 of FIG. 24. Duplicate descriptions will be omitted.

The UI 2520 may include at least one of a first projection candidate area 2521, a GUI 2531 representing the first projection candidate area 2521, and information 2541 representing the size of the first projection candidate area 2521.

The UI 2520 may include at least one of a second projection candidate area 2522, a GUI 2532 representing the second projection candidate area 2522, and information 2542 representing the size of the second projection candidate area 2522.

The UI 2520 may include at least one of a third projection candidate area 2523, a GUI 2533 representing the third projection candidate area 2523, and information 2543 representing the size of the third projection candidate area 2543.

The UI 2520 may include at least one of a fourth projection candidate area 2524, a GUI 2534 representing the fourth projection candidate area 2524, and information 2544 representing the size of the fourth projection candidate area 2524.

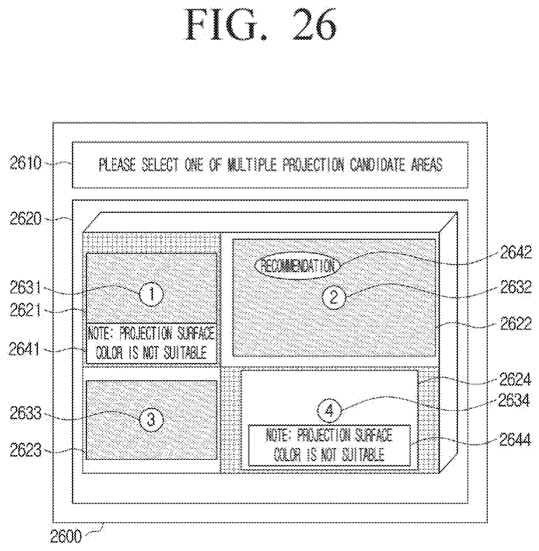

FIG. 26 is a diagram for describing the guide screen for selecting the target area according to an embodiment.

A guide screen 2600 of FIG. 26 may correspond to the guide screen 2400 of FIG. 24. A UI 2610 and a UI 2620 may correspond to the UI 2410 and the UI 2420 of FIG. 24. Duplicate descriptions will be omitted.

The UI 2620 may include at least one of information 2641 and 2644 representing that a specific projection candidate area is not recommended or information 2642 representing that a specific projection candidate area is recommended.

To determine the target area for outputting the projection image, the electronic apparatus 100 may determine a single target area. The electronic apparatus 100 may provide a guide screen 2600 including the information for recommending the determined target area.

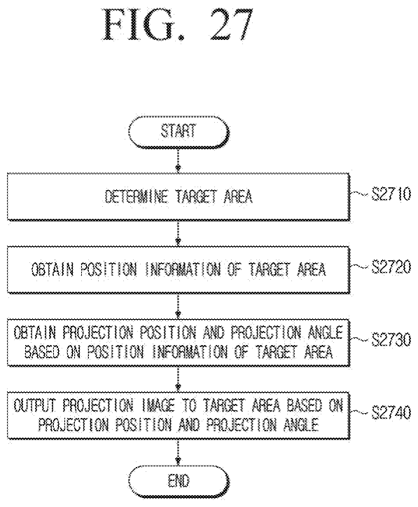

FIG. 27 is a diagram for describing an operation of performing projection settings according to an embodiment.

Referring to FIG. 27, the electronic apparatus 100 may determine the target area (S2710). Operation S2710 may correspond to operations S1960 of FIG. 19, S2060 of FIG. 20, and S2180 of FIG. 21. Duplicate descriptions will be omitted.

The electronic apparatus 100 may obtain the position information of the target area (S2720). The position information may include coordinate information representing the target area.

The electronic apparatus 100 may obtain the projection position and projection angle based on the position information of the target area (S2730).

According to various embodiments, the electronic apparatus 100 may obtain at least one of the projection position and the projection angle based on the position information of the target area.

The electronic apparatus 100 may output the projection image to the target area based on the projection position and the projection angle (S2740).

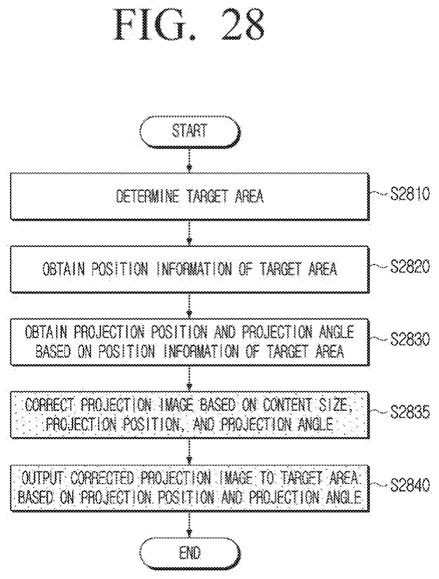

FIG. 28 is a diagram for describing an image correction operation according to an embodiment.

Operations S2810, S2820, S2830, and S2840 of FIG. 28 may correspond to operations S2710, S2720, S2730, and S2740 of FIG. 27. Duplicate descriptions will be omitted.

Upon obtaining the projection position and the projection angle, the electronic apparatus 100 may correct the projection image based on at least one of the content size, the projection position, and the projection angle (S2835). The electronic apparatus 100 may perform the image correction function on the projection image. The image correction function may include performing a keystone correction function, a leveling correction function, and a resolution change function.

The electronic apparatus 100 may output the corrected projection image to the target area based on the projection position and projection angle (S2840).

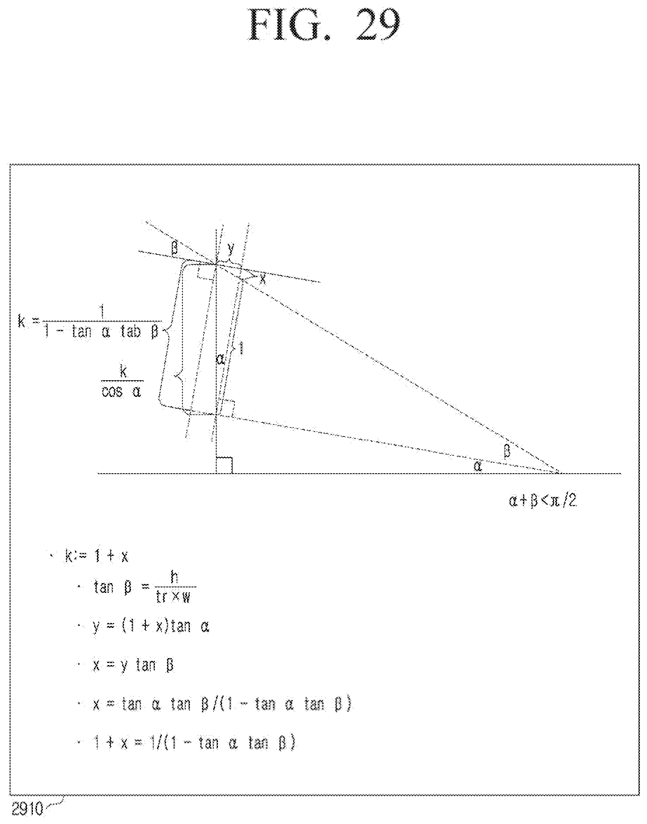

FIG. 29 is a diagram for describing a screen distortion ratio according to an embodiment.

Referring to embodiment 2910 of FIG. 29, the electronic apparatus 100 may calculate the degree (or ratio) of screen distortion as the screen is rotated in the y-axis (pitch) direction.

Embodiment 2910 indicates that the electronic apparatus 100 is rotated by α in the y-axis (pitch) direction.

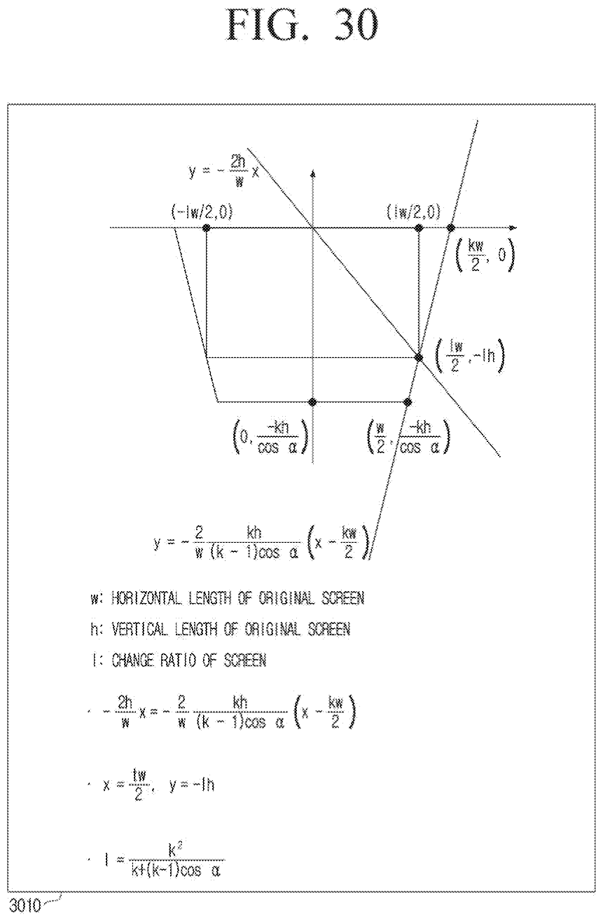

FIG. 30 is a diagram for describing the screen correction ratio according to an embodiment.

Referring to embodiment 3010 of FIG. 30, it is assumed that the electronic apparatus 100 performs the image correction function while being rotated by α in the y-axis (pitch) direction. Embodiment 3010 may illustrate a process for calculating a screen change ratio when performing the image correction function.

w may represent the horizontal length of the original image (projection image) before performing the image correction function.

h may represent the vertical length of the original image (projection image) before performing the image correction function.

Other values are described in embodiment 2910 of FIG. 29.

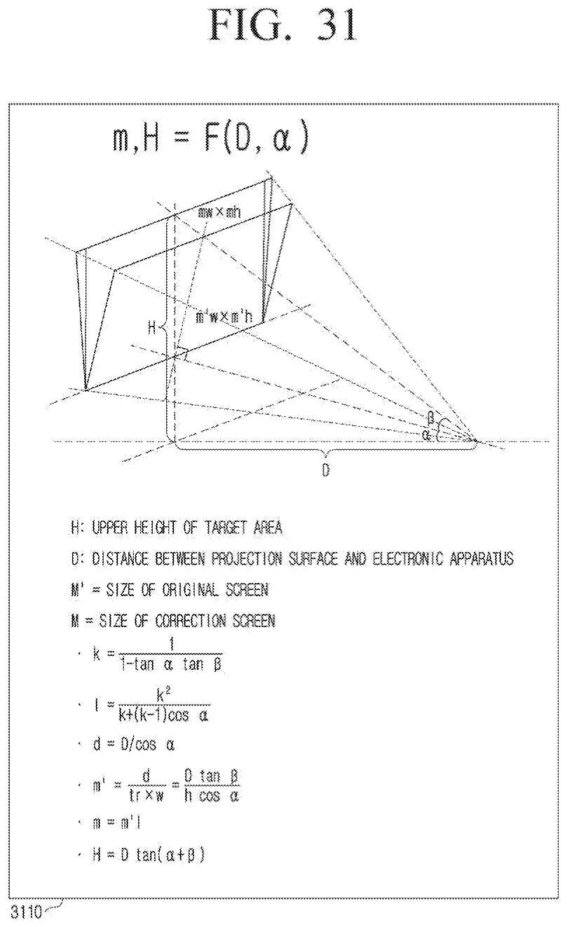

FIG. 31 is a diagram for describing the screen correction ratio according to an embodiment.

Embodiment 3110 of FIG. 31 may illustrate a process for calculating the size of the original image (projection image) before performing the image correction function and the size of the original image (projection image) before performing the image correction function.

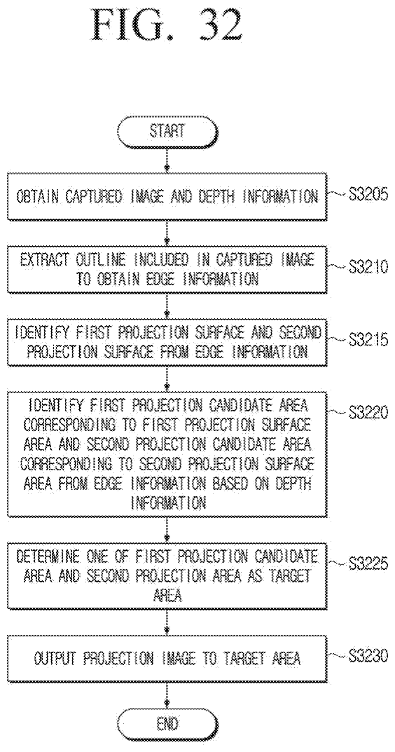

FIG. 32 is a diagram for describing a control method of the electronic apparatus 100 according to an embodiment.

Referring to FIG. 32, the control method of the electronic apparatus 100 includes obtaining the captured image and the depth information (S3205), extracting an outline included in the captured image to obtain the edge information (S3210), identifying the first projection surface area and the second projection surface area from the edge information (S3215), identifying the first projection candidate area corresponding to the first projection surface area and the second projection candidate area corresponding to the second projection surface area from the edge information based on the depth information (S3220), determining one of the first projection candidate area and the second projection candidate area as the target area (S3225), and outputting the projection image to the target area (S3230).

In the obtaining the captured image and the depth information (S3205), the captured image is obtained through the image sensor included in the electronic apparatus 100 and the depth information is obtained through the distance sensor included in the electronic apparatus 100, and in the identifying the first projection candidate area and the second projection candidate area, the tilt information of the first projection surface area and the second tilt information of the second projection surface area are obtained based on the depth information, the first projection candidate area is identified based on the first tilt information, and the second projection candidate area is identified based on the second tilt information, and the depth information may include the sparse depth map.

In the obtaining the edge information (S3210), at least one object may be identified from the captured image and the edge information including the outline of the at least one object may be obtained.

In the identifying the first projection surface area and the second projection surface area (S3215), an area corresponding to a plane greater than or equal to the threshold size in the edge information may be identified as the first projection surface area and the second projection surface area.

In the identifying the first projection candidate area and the second projection candidate area (S3220), the first projection candidate area and the second projection candidate area may be identified based on the preset the resolution information.

In the determining the target area (S3225), area corresponding to the larger value of the first size of the first projection candidate area and the second size of the second projection candidate area may be determined as the target area.

In the determining the target area (S3225), the content information related to the projection image may be obtained, and when the content type included in the content information is a preset type, the target area may be determined based on the user's gaze direction.

The captured image is the first captured image, and in the determining the target area (S3225), when the content type included in the content information is the preset type, the second captured image may be obtained through the image sensor included in the electronic apparatus 100, the user's gaze direction included in the second captured image may be identified, and the area corresponding to the user's gaze direction may be determined as the target area from among the first projection candidate area and the second projection candidate area.

The control method further includes obtaining the position information of the target area and a step of obtaining the projection position and the projection angle based on the position information of the target area, and in the outputting the projection image (S3230), the projection image may be output to the target area based on the projection position and the projection angle.

The projection image is the first projection image, and the control method further includes performing the correction function on the first projection image based on the projection position and the projection angle to obtain the second projection image, and in the outputting the projection image (S3230), the second projection image may be output to the target area.

The above-described methods according to various embodiments of the present disclosure may be implemented in a form of application that may be installed in the existing electronic apparatus.

The above-described methods according to various embodiments of the present disclosure may be implemented only by software upgrade or hardware upgrade of the existing electronic apparatus.

Various embodiments of the disclosure described above may also be performed through an embedded server included in the electronic apparatus or the external server of at least one of the electronic apparatus or the display device.

According to an embodiment of the disclosure, various embodiments described above may be implemented by software including instructions stored in a machine-readable storage medium (for example, a computer-readable storage medium). A machine is a device capable of calling a stored instruction from a storage medium and operating according to the called instruction, and may include the electronic apparatus of the disclosed embodiments. In the case in which a command is executed by the processor, the processor may directly perform a function corresponding to the command or other components may perform the function corresponding to the command under a control of the processor. The command may include codes created or executed by a compiler or an interpreter. The machine-readable storage medium may be provided in a form of a non-transitory storage medium. The term “non-transitory” means that the storage medium is tangible without including a signal, and does not distinguish whether data are semi-permanently or temporarily stored in the storage medium.

According to an embodiment of the disclosure, the above-described methods according to the diverse embodiments may be included and provided in a computer program product. The computer program product may be traded as a product between a seller and a purchaser. The computer program product may be distributed in a form of a storage medium (for example, a compact disc read only memory (CD-ROM)) that may be read by the machine or online through an application store. In case of the online distribution, at least a portion of the computer program product may be at least temporarily stored in a storage medium such as a memory of a server of a manufacturer, a server of an application store, or a relay server or be temporarily generated.

Each of components (for example, modules or programs) according to various embodiments described above may include a single entity or a plurality of entities, and some of the corresponding sub-components described above may be omitted or other sub-components may be further included in the diverse embodiments. Alternatively or additionally, some components (e.g., modules or programs) may be integrated into one entity and perform the same or similar functions performed by each corresponding component prior to integration. Operations performed by the modules, the programs, or the other components according to the diverse embodiments may be executed in a sequential manner, a parallel manner, an iterative manner, or a heuristic manner, at least some of the operations may be performed in a different order or be omitted, or other operations may be added.

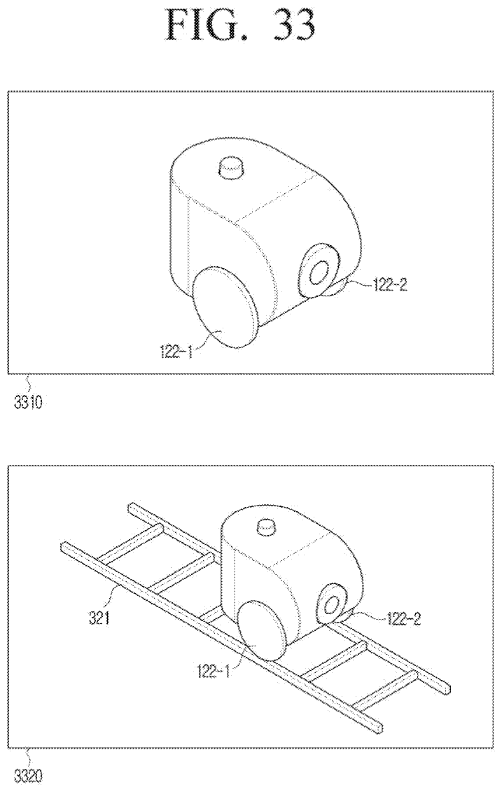

FIG. 33 is a diagram illustrating a mobile projector according to an embodiment.

The electronic apparatus 100 may be implemented as a mobile device. The electronic apparatus 100 may be implemented as a mobile projector or a mobile image output device.

The electronic apparatus 100 may include the moving member 122. The moving member 122 may refer to a member for moving from the first position to the second position in the space where the electronic apparatus 100 is arranged. The moving member 122 may include at least one wheel (e.g., a circular wheel). The electronic apparatus 100 may move to the target position (designated position) via the moving member.

Referring to embodiment 3310 of FIG. 33, the electronic apparatus 100 may move by a user's pushing force. When the user pushes the electronic apparatus 100, the moving member 122 of the electronic apparatus 100 may rotate. The moving member 122 may include a wheel, and the electronic apparatus 100 may move by the moving member 122 that rotates due to an external force.

Referring to embodiment 3320 of FIG. 33, the moving member 122 may move via a fixed member 3321. The fixed member 3321 may include a movable rail. The electronic apparatus 100 may be placed on the movable rail. The electronic apparatus 100 may move on the movable rail. The electronic apparatus 100 does not include the movable rail as a component thereof; the movable rail may be a component installed by the user.

The electronic apparatus 100 may control the moving member 122 to move the electronic apparatus 100 using the force generated by the driving unit 120. The electronic apparatus 100 may generate force to be transmitted to the moving member 122 using the motor included in the driving unit 120.

When the user input or control command is received, the electronic apparatus 100 may rotate the moving member 122 by transmitting the force generated through the motor to the moving member 122. The electronic apparatus 100 may control the moving member 122 to adjust the rotation speed, the rotation direction, etc. The electronic apparatus 100 may perform the movement operation (or movement function) by controlling the moving member 122 based on the target position, the direction of travel, etc.

The electronic apparatus 100 may travel based on at least one of a preset movement speed or a preset acceleration. The preset movement speed or acceleration may be changed according to user settings.

According to various embodiments, the electronic apparatus 100 may control the speed or acceleration based on the preset event. The electronic apparatus 100 may identify whether the preset event has occurred. To identify whether the preset event has occurred, the electronic apparatus 100 may obtain at least one of travel data (or map data) or sensing data.

When the electronic apparatus 100 identifies the preset event as occurring, the electronic apparatus 100 may travel by changing the speed or acceleration. The preset event may include at least one of an event for traveling to the target position or an event for identifying the preset object.

The event for traveling to the target position may include at least one of an event for starting traveling at the current position or an event for stopping traveling at the target position. When the control command (or user input) for traveling from the current position to the target position is obtained, the electronic apparatus 100 may increase at least one of the speed or acceleration. When it is determined that the electronic apparatus 100 has reached the threshold distance from the target position, the electronic apparatus 100 may decrease at least one of the speed or acceleration.

The preset object may include an obstacle object. When an obstacle object is identified, the electronic apparatus 100 may decrease the acceleration. The acceleration may increase in the opposite direction to the direction of travel. When the acceleration decreases, the speed increase amount of the electronic apparatus 100 decreases, and when the acceleration is in the opposite direction to the direction of travel, the speed may decrease.

According to various embodiments, the electronic apparatus 100 may move over the fixed member 3321 by the force transmitted through the driving unit 120. The electronic apparatus 100 may automatically move the fixed member 3321 using the force generated by the driving unit 120 rather than an external force. The automatic movement operation may be described as a sliding type.

According to various embodiments, the electronic apparatus 100 may move to the identified target position based on the user input. The target position may include a target position to which the electronic apparatus 100 is to move. The user may input a command to the electronic apparatus 100 to move to the target position. The electronic apparatus 100 may receive the user input for moving to the target position.

For example, the user input may include information about the position to which the electronic apparatus 100 is to move. The electronic apparatus 100 may determine the position information included in the user input as the target position and move to the target position.

For example, the user input may include the information about the position of the projection surface 10 on which the electronic apparatus 100 outputs the projection image. The electronic apparatus 100 may determine the target position at which the electronic apparatus 100 will output the projection image based on the position information of the projection surface 10 included in the user input. The electronic apparatus 100 may move to the determined target position.

The user input including the target position may be received (or obtained) through the external device connected to the electronic apparatus 100.

For example, the external device may include a remote control device capable of communicating with the electronic apparatus 100.

For example, the external device may include a user terminal device capable of communicating with the electronic apparatus 100.

The electronic apparatus 100 may identify the target position through the sensor unit 121. The sensor unit 121 may obtain sensing data about the surroundings of the electronic apparatus 100. The electronic apparatus 100 may identify the target position based on the sensing data.

For example, the electronic apparatus 100 may identify, from sensing data, a laser beam emitted by a user to point to a target position. When the user points the laser beam at the target position with a laser, etc., the electronic apparatus 100 may sense the position of the laser beam to identify the target position.

For example, the electronic apparatus 100 may identify, from the sensing data, a user gesture indicating a target position. When the user points the target position with a finger (or an object representing a pointing direction), the electronic apparatus 100 may sense the user's gesture to identify the target position.

The electronic apparatus 100 may include the projection unit 112. The electronic apparatus 100 may control the projection unit 112 to output the projection image.

According to various embodiments, the electronic apparatus 100 may include the projection unit 112 utilizing ultra-short throw (UST) method. The ultra-short throw method may refer to a method of projecting an image at a relatively close distance (e.g., 1 m or less). Despite the close distance, a clear projection image may be output to the projection surface 10.

According to various embodiments, the electronic apparatus 100 may include the projection unit 112 utilizing a conventional method. The projection unit 112 may include various types of light sources. For example, the projection unit 112 may include at least one light source of a lamp, an LED, and a laser. The normal method may include a method of outputting the projection image at a distance exceeding 1 m.

According to various embodiments, the electronic apparatus 100 may output the projection image using both the ultra-short throw method and the normal method at the same projection position. The electronic apparatus 100 may output the projection image using both the ultra-short throw method and the normal method at the same time.

The electronic apparatus 100 may segment a first area and a second area from the entire projection area for projecting the projection image. The electronic apparatus 100 may output the projection image to the first area using the ultra-short throw method and to the second area using the normal method.

For example, the projection image output to the first area and the projection image output to the second area may be sub-images generated based on the same projection image (source image).

For example, the projection image output to the first area and the projection image output to the second area may be different projection images.

For example, the electronic apparatus 100 may output the projection image to the first area using the ultra-short throw method and to the second area using the normal method by using the same light source.

For example, the electronic apparatus 100 may output the projection image to the first area using the ultra-short throw method and to the second area using the normal method by using different light sources. The electronic apparatus 100 may output the projection image to the first area using the ultra-short throw method through a first light source output from a first light source unit, and may output the projection image to the second area using the normal method through a second light source output from a second light source unit.

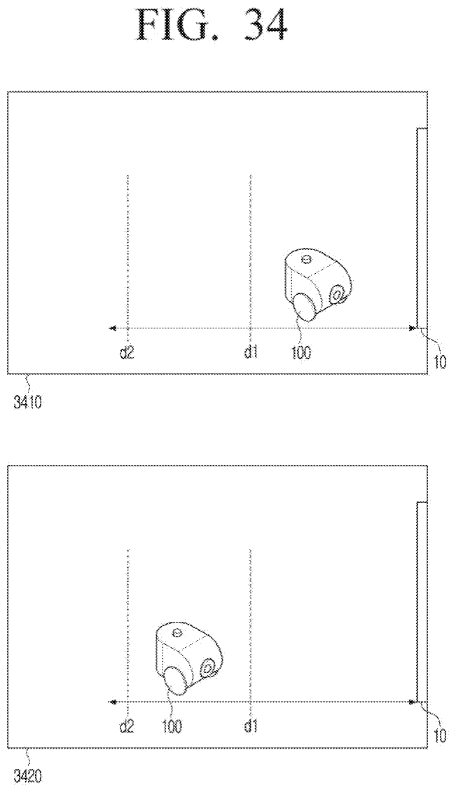

FIG. 34 is a diagram for describing the distance between the projection surface 10 and the electronic apparatus 100 according to an embodiment.

Referring to FIG. 34, the electronic apparatus 100 may determine a projection method based on the distance between the electronic apparatus 100 and the projection surface 10.

The projection method may include at least one of the ultra-short throw (UST) method or the normal method. The ultra-short throw method may be described as the first method, and the normal method may be described as the second method. The electronic apparatus 100 may obtain (or calculate) the distance between the position of the electronic apparatus 100 and the position of the projection surface 10 and determine the projection method based on the obtained distance.

When the distance between the electronic apparatus 100 and the projection surface 10 is less than or equal to the threshold distance, the electronic apparatus 100 may output the projection image using the ultra-short throw method. When the distance between the electronic apparatus 100 and the projection surface 10 exceeds the threshold distance, the electronic apparatus 100 may output the projection image using the normal method.

Referring to embodiment 3410, a situation is described where the distance between the electronic apparatus 100 and the projection surface 10 is less than or equal to a threshold distance d1. The electronic apparatus 100 may output the projection image using the ultra-short throw method.

Referring to embodiment 3420, a situation is described where the distance between the electronic apparatus 100 and the projection surface 10 exceeds the threshold distance d1. The electronic apparatus 100 may output the projection image using the normal method.

The threshold distance d1 may be described as a first threshold distance. When the distance between the electronic apparatus 100 and the projection surface 10 exceeds a second threshold distance d2, the electronic apparatus 100 may control the distance between the electronic apparatus 100 and the projection surface 10 to be within the second threshold distance d2. The electronic apparatus 100 may determine the target position where the distance between the electronic apparatus 100 and the projection surface 10 is within the second threshold distance d2 and move to the target position. After movement, the electronic apparatus 100 may output the projection image.

According to various embodiments, the electronic apparatus 100 may include a plurality of lenses.

The electronic apparatus 100 may include a first lens corresponding to the ultra-short throw (UST) method. The electronic apparatus 100 may include a second lens corresponding to the normal method. The first and second lenses may have different refractive indices.

The electronic apparatus 100 may determine the projection method using the projection environment (or ambient environment). The electronic apparatus 100 may determine a lens corresponding to the determined method. The electronic apparatus 100 may output the projection image through the determined lens.

According to various embodiments, the electronic apparatus 100 may include an integrated lens (or first lens). Based on the integrated lens, the electronic apparatus 100 may output the projection image in the ultra-short throw (UST) method and the normal method. The electronic apparatus 100 may implement various projection methods with a single lens.

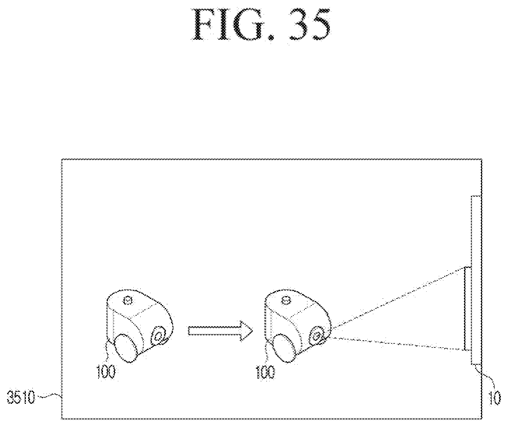

FIG. 35 is a diagram for describing a movement operation of an electronic apparatus 100, according to an embodiment.

Referring to embodiment 3510 of FIG. 35, the electronic apparatus 100 may move based on the projection position. The electronic apparatus 100 may obtain the projection position for moving the electronic apparatus 100.

According to various embodiments, the electronic apparatus 100 may move based on the projection position while not outputting the projection image. Once the projection position is identified (or obtained), the electronic apparatus 100 may determine whether the projection image is being output. When the projection image is not being output, the electronic apparatus 100 may move based on the projection position.

When the projection image is being output, the electronic apparatus 100 may stop projecting the projection image. After stopping outputting the projection image, the electronic apparatus 100 may move based on the projection position.

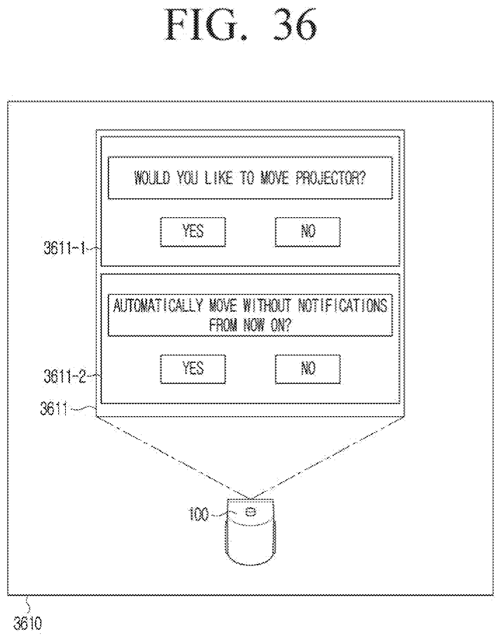

FIG. 36 is a diagram for describing a notification regarding position movement, according to an embodiment.

Referring to embodiment 3610 of FIG. 36, when a movement event is identified based on the projection position, the electronic apparatus 100 may output a movement notification screen 3611.

The movement notification screen 3611 may include at least one of a UI 3611-1 requesting a user input regarding the movement of the electronic apparatus 100 or a UI 3611-2 for setting whether to display the movement notification screen.

When a user input including a movement command is received through the UI 3611-1, the electronic apparatus 100 may move based on the projection position.

When the user input is received through the UI 3611-2 to set the movement without the movement notification screen, the electronic apparatus 100 may no longer display the movement notification screen 3611. When the electronic apparatus 100 moves after receiving the user input, the electronic apparatus 100 may not display the movement notification screen 3611.

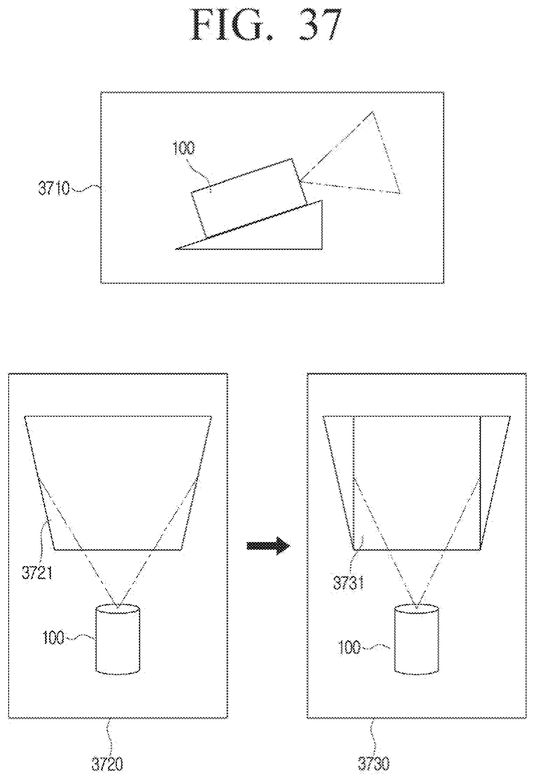

FIG. 37 is a diagram for describing the keystone correction function according to an embodiment.

Referring to embodiment 3710 of FIG. 37, when the tilt of the electronic apparatus 100 changes due to the positional movement, the electronic apparatus 100 may perform the keystone correction function. The keystone correction function may include an operation of correcting a trapezoidal image into a rectangular shape.

The electronic apparatus 100 may output the projection image while there is a vertical tilt.

Referring to embodiment 3720, the electronic apparatus 100 may output a projection image 3721 while there is a vertical tilt. Due to the vertical tilt, the projection image 3721 may be output in a trapezoidal shape rather than a rectangle that is an original image shape. To address issues occurring from the presence of the horizontal tilt, the electronic apparatus 100 may perform the keystone function.

Referring to embodiment 3730, the electronic apparatus 100 may perform a keystone function to modify the original image so that the finally output projection image 3731 becomes rectangular.

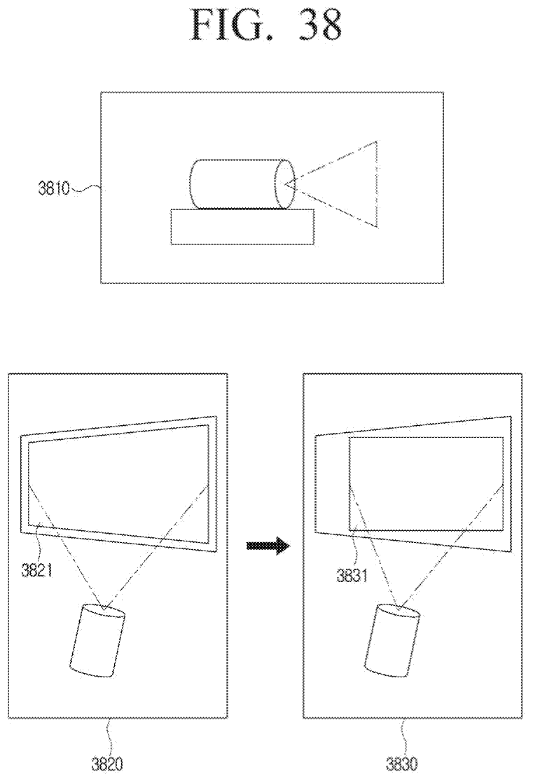

FIG. 38 is a diagram for describing the keystone correction function according to an embodiment.

Referring to embodiment 3810 of FIG. 38, when the tilt of the electronic apparatus 100 changes due to the positional movement, the electronic apparatus 100 may perform the keystone correction function.

The electronic apparatus 100 may output the projection image while there is a horizontal tilt.

Referring to embodiment 3820, the electronic apparatus 100 may output a projection image 3821 while there is the horizontal tilt. Due to the vertical tilt, the projection image 3821 may be output in a trapezoidal shape rather than a rectangle that is an original image shape due to the horizontal tilt. To address issues occurring from the presence of the horizontal tilt, the electronic apparatus 100 may perform the keystone function.

Referring to embodiment 3830, the electronic apparatus 100 may perform a keystone function to modify the original image so that the finally output projection image 3831 becomes rectangular.

According to various embodiments, the electronic apparatus 100 may perform the keystone correction at various points in time. It is assumed that the electronic apparatus 100 is positioned at the first position (current position). It is also assumed that the electronic apparatus 100 moves to the second position (projection position) and outputs the projection image.

For example, the electronic apparatus 100 may perform keystone correction at the first position. After completing the keystone correction at the first position, the electronic apparatus 100 may move to the second position. The electronic apparatus 100 may output the projection image with the keystone correction performed at the second position.

For example, the electronic apparatus 100 may perform keystone correction while moving from the first position to the second position. The electronic apparatus 100 may output the projection image with the keystone correction performed at the second position.

For example, the electronic apparatus 100 may perform keystone correction at the second position. The electronic apparatus 100 may output the projection image with the keystone correction performed at the second position.

According to various embodiments, the electronic apparatus 100 may output the projection image while moving. To output the projection image while moving, the electronic apparatus 100 may perform the keystone correction in real time while moving. The electronic apparatus 100 may perform the keystone correction based on each position while moving from the first position to the second position. The electronic apparatus 100 may output the projection image on which the keystone correction has performed in real time at each position while moving. The keystone correction may be increasingly performed at each position.

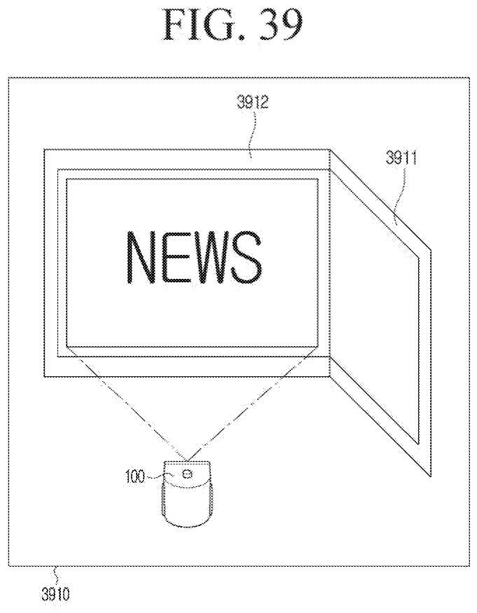

FIG. 39 is a diagram for describing an operation of changing the projection area, according to an embodiment.

Referring to embodiment 3910 of FIG. 39, when the size of the projection image changes, the electronic apparatus 100 may newly identify the projection surface corresponding to the changed size. The electronic apparatus 100 may determine the projection surface corresponding to the size of the projection image. It is assumed that there are multiple candidate projection surfaces in the space where the electronic apparatus 100 is arranged. The electronic apparatus 100 may output a projection image to a first projection surface 3911 among the multiple candidate projection surfaces. Changing the size of the projection image may include an operation of changing the resolution of the projection image or an operation of changing the aspect ratio of the projection image.

When the size of the projection image increases, the electronic apparatus 100 may determine whether the increased size of the projection image may be projected onto the first projection surface 3911. The electronic apparatus 100 may compare the size of the projection image with the size of the first projection surface 3911. When the size of the projection image is greater than that of the first projection surface 3911, the electronic apparatus 100 may determine to change the projection surface. The electronic apparatus 100 may select a second projection surface 3912 having a size greater than that of the projection image from among the multiple candidate projection surfaces. The electronic apparatus 100 may output the projection image to the second projection surface 3912.

According to various embodiments, the electronic apparatus 100 may determine whether to move based on attribute information of content including the projection image. The attribute information of the content may include at least one of information about the ratio of high-frequency components included in the content and information about whether to include an edge object.

When the ratio of the high-frequency components among the plurality of components included in the content is greater than or equal to a threshold ratio, the electronic apparatus 100 may move toward the projection surface 10.

When the content includes the edge object, the electronic apparatus 100 may move toward the projection surface 10.

When the electronic apparatus 100 moves toward the projection surface 10, the projection image may become clearer. The clarity of the projection image may indicate a relatively high quality of the projection image.

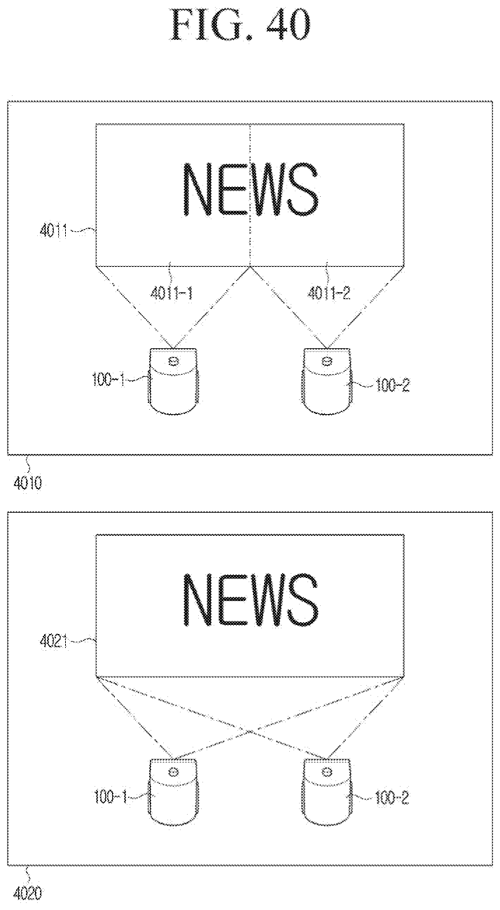

FIG. 40 is a diagram for describing an operation of outputting the projection image using a plurality of devices according to an embodiment.

Referring to embodiment 4010 of FIG. 40, according to various embodiments, a projection image 4011 may be output to the projection surface 10 by a plurality of electronic apparatuses including a projection unit. The plurality of electronic apparatuses may include a first electronic apparatus 100-1 and a second electronic apparatus 100-2.

The first electronic apparatus 100-1 may output a partial area 4011-1 of the projection image 4011 to the projection surface 10, and the second electronic apparatus 100-2 may output a partial area 4011-2 of the projection image to the projection surface 10. The electronic apparatus 100 may perform a synchronization operation to synchronize the portion projected by the first electronic apparatus 100-1 and the portion projected by the second electronic apparatus 100-2. The synchronization operation may include an operation of the plurality of electronic apparatuses to output images (or frames) at the same point in time.

The electronic apparatus 100 may perform an edge blending function when outputting the projection image to the plurality of electronic apparatuses. The edge blending function may include an operation in which a plurality of electronic apparatuses project respective images.

When the position of the electronic apparatus 100 changes, the electronic apparatus 100 may re-perform the edge blending function.

Referring to embodiment 4020 of FIG. 40, the plurality of electronic apparatuses may display the same projection image 4021 in an overlapping manner on the projection surface 10. When different electronic apparatuses 100 output the projection images 4021 in the same area, the brightness may increase. The plurality of electronic apparatuses may perform a synchronization operation to synchronize the projection images 4021.

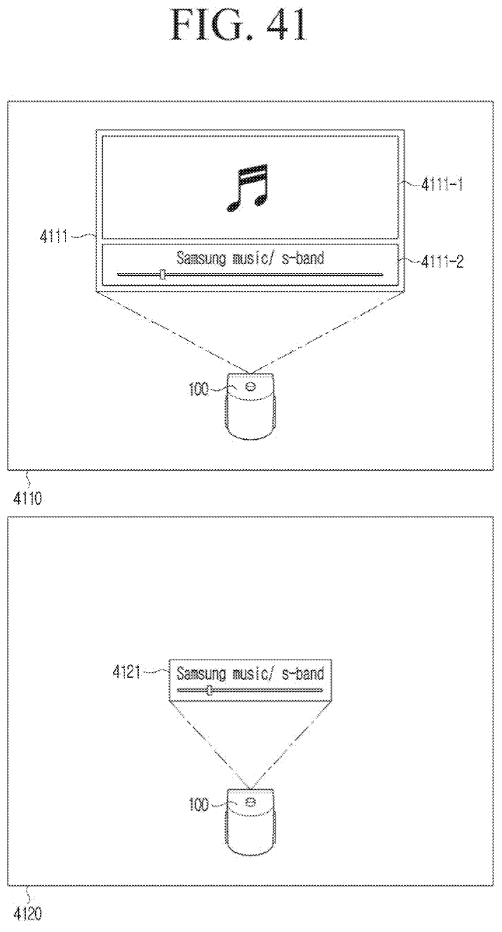

FIG. 41 is a diagram for describing an operation of changing the projection image based on a distance.

By reducing the projection area while moving toward the projection surface 10, the size of the projection image (content) may be reduced. By reducing the size of the projection image, it is possible to save power consumed in outputting the projection image.

Referring to embodiment 4110 of FIG. 41, the electronic apparatus 100 may output a projection image 4111 at the projection position positioned the first distance away from the projection surface. The projection image 4111 may include a first area 4111-1 and a second area 4111-2. The first area 4111-1 and the second area 4111-2 may include different contents. The electronic apparatus 100 may segment the multiple areas 4111-1 and 4111-2 using the edge lines in the projection image 4111.

The electronic apparatus 100 may identify an event for moving the projection position closer to the projection surface while reducing a size of the projection image. The electronic apparatus 100 may identify the target area 4111-2 from among the multiple areas 4111-1 and 4111-2 based on the preset criteria. The target area according to the preset criteria may include at least one of a smaller area and an area selected as a main area by the user settings.

Referring to embodiment 4120 of FIG. 41, the electronic apparatus 100 may move closer to the projection surface, but may output only a projection image 4121 corresponding to the target area 4111-2 among the multiple areas 4111-1 and 4121-2. The electronic apparatus 100 may convert the size of the image corresponding to the target area 4111-2 and output a new projection image 4121.

For example, when the content is music-related content, the electronic apparatus 100 may move toward the projection surface 10. When moving toward the projection surface 10, the electronic apparatus 100 may reduce the battery consumption by reducing the size of the first projection image when outputting the content. The first projection image related to the music content may include a first area representing an image related to music and a second area representing music playback information. When the event for reducing the size of the first projection image is identified, the electronic apparatus 100 may generate the second projection image including only the second area and output the generated second projection image. The second projection image may be smaller in size than the first projection image with respect to the projection surface. The position at which the second projection image is output may be closer to the projection surface than the position at which the first projection image is output.

The electronic apparatus 100 may include a microphone 118. The electronic apparatus 100 may receive the user input through the microphone 118. The user input may include a voice input. The electronic apparatus 100 may perform a function corresponding to the user input based on the user input including the user voice.

The function corresponding to the user input may include a full-screen output (full view) function. The full-screen output function may be described as a full-screen output mode. The electronic apparatus 100 may receive a voice command and perform a function corresponding to the voice command.

Although embodiments of the present disclosure have been illustrated and described hereinabove, the present disclosure is not limited to the above-described specific embodiments, but may be variously modified by those skilled in the art to which the present disclosure pertains without departing from the scope of the present disclosure as disclosed in the accompanying claims. These modifications should also be understood to fall within the spirit of the present disclosure.

1. An electronic apparatus, comprising:
a sensor unit including at least one sensor;
a memory;
a projection unit to output a projection image; and
at least one processor configured to:
obtain edge information, based on a captured image of a projection surface area on which the projection image is to be output, through the sensor unit, and
control the projection unit to output, based on depth information obtained through the sensor unit, the projection image corrected to correspond to a projection area included in the projection surface area based on at least one of a first projection surface area and a second projection surface area included in the edge information obtained based on the captured image.

2. The electronic apparatus as claimed in claim 1, wherein the at least one processor is configured to identify an area corresponding to a plane having a size greater than or equal to a threshold size in the edge information as the first projection surface area and the second projection surface area.

3. The electronic apparatus as claimed in claim 1, wherein the at least one processor is configured to identify a first projection candidate area corresponding to the first projection surface area and a second projection candidate area corresponding to the second projection surface area from the edge information based on the depth information and preset resolution information,
identify one of the first projection candidate area and the second projection candidate area as the projection area, and
control the projection unit to output the projection image to the projection area.

4. The electronic apparatus as claimed in claim 3, wherein the at least one processor is configured to obtain the captured image through an image sensor included in the sensor unit,
obtain first tilt information of the first projection surface area and second tilt information of the second projection surface area based on the depth information obtained through a distance sensor included in the sensor unit,
identify the first projection candidate area based on the first tilt information, and
identify the second projection candidate area based on the second tilt information, and
the depth information includes a sparse depth map.

5. The electronic apparatus as claimed in claim 3, wherein the at least one processor is configured to obtain the edge information which includes an outline of at least one object from the captured image.

6. The electronic apparatus as claimed in claim 3, wherein the at least one processor is configured to identify an area corresponding to a value that is larger of a first size of the first projection candidate area and a second size of the second projection candidate area as the projection area.

7. The electronic apparatus as claimed in claim 3, wherein the at least one processor is configured to obtain content information related to the projection image, and
identify the projection area based on a user's gaze direction when a content type included in the content information is a preset type.

8. The electronic apparatus as claimed in claim 7, wherein the captured image is a first captured image, and
the at least one processor is configured to obtain a second captured image through an image sensor included in the sensor unit based on the content type included in the content information being the preset type,
identify the user's gaze direction included in the second captured image, and
identify an area corresponding to the user's gaze direction from among the first projection candidate area and the second projection candidate area as the projection area.

9. The electronic apparatus as claimed in claim 1, wherein the at least one processor is configured to obtain position information of the projection area,
obtain a projection position and a projection angle based on the position information of the projection area, and
control the projection unit to output the projection image to the projection area based on the projection position and the projection angle.

10. The electronic apparatus as claimed in claim 9, wherein the projection image is a first projection image, and
the at least one processor is configured to perform a correction function on the first projection image based on the projection position and the projection angle to obtain a second projection image, and
control the projection unit to output the second projection image to the projection area.

11. A control method of an electronic apparatus, comprising:
obtaining edge information based on a captured image of a projection surface area on which a projection image is to be output; and
outputting a projection image corrected to correspond to a projection area included in the projection surface area based on depth information and at least one of a first projection surface area and a second projection surface area included in the edge information obtained based on the captured image.

12. The control method as claimed in claim 11, wherein the control method comprising:
identifying an area corresponding to a plane greater than or equal to a threshold size in the edge information as the first projection surface area and the second projection surface area.

13. The control method as claimed in claim 11, wherein the control method comprising:
identifying a first projection candidate area corresponding to the first projection surface area and a second projection candidate area corresponding to the second projection surface area from the edge information based on the depth information and preset resolution information, and
identifying one of the first projection candidate area and the second projection candidate area as the projection area, and
wherein the outputting of the projection image comprises:
outputting the projection image to the projection area.

14. The control method as claimed in claim 13, wherein the identifying of the projection area comprises:
obtaining the captured image through an image sensor,
obtaining first tilt information of the first projection surface area and second tilt information of the second projection surface area based on the depth information obtained through a distance sensor,
identifying the first projection candidate area based on the first tilt information, and
identifying the second projection candidate area based on the second tilt information, and
the depth information includes a sparse depth map.

15. The control method as claimed in claim 13, wherein, the obtaining of the edge information comprises:
obtaining the edge information including an outline of at least one object from the captured image.
